(19) United States
(12) Patent Application Publication
(10) Pub. No.: US 2008/0295506 A1
(43) Pub. Date: Dec. 4, 2008

(54) VEHICLE BEHAVIOR CONTROL APPARATUS

(75) Inventors: Takanobu Saito, Kamakura-shi (JP); Motohiro Higuma, Atsugi-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/130,281

(22) Filed: May 30, 2008

(30) Foreign Application Priority Data
May 31, 2007 (JP) 2007-145206

(51) Int. Cl. F16D 31/00

(52) U.S. Cl. 60/390; 701/41

(57) ABSTRACT

A hydraulic circuit includes a first pressurizing section for pressurizing a wheel cylinder by operating a master cylinder, and a second pressurizing section for pressurizing the wheel cylinder independently of operation of the master cylinder. A control unit determines whether a first operation request according to a physical relationship between a vehicle and an environment surrounding the vehicle is present; determines whether a second operation request according to a physical behavior of the vehicle is present; activates the first pressurizing section when the first operation request is present and the second operation request is absent; activates the second pressurizing section when the first operation request is absent and the second operation request is present; and keeps the first pressurizing section activated and activates the second pressurizing section, when the second operation request turns present under condition that the first pressurizing section is activated in response to the first operation request.

### BACKGROUND OF THE INVENTION

The present invention relates to vehicle behavior control apparatuses or systems for assisting a driver to suitably operate a vehicle, and/or preventing the vehicle from entering undesirable operating states.

Japanese Patent Application Publication No. 2000-255405 discloses a braking control device for a vehicle. The braking control device includes a brake booster controlled to regulate an internal pressure of a master cylinder independently of driver's operation of a brake pedal. When the vehicle is in a state of oversteer or understeer, then the braking control device controls behavior of the vehicle by driving the brake booster, and regulating internal pressures of wheel cylinder.

### SUMMARY OF THE INVENTION

According to Japanese Patent Application Publication No. 2000-255405, during operation of the braking control device, fluid communication between the wheel cylinders as controlled objects and the master cylinder is allowed. This causes the controlled internal pressures of the wheel cylinders to be transmitted to the brake pedal. This may cause undesirable or uncomfortable feels to be transmitted to a driver through the brake pedal, especially when the controlled internal pressures of the wheel cylinders are high, and frequencies of vibration of the pressures are high.

In view of the foregoing, it is desirable to provide a vehicle behavior control apparatus which is capable of automatically controlling behavior of a vehicle by regulating wheel cylinder pressures without causing undesirable feels to be transmitted to a driver through a brake pedal.

According to one aspect of the present invention, a vehicle behavior control apparatus comprises: a master cylinder arranged to pressurize a wheel cylinder of a vehicle in accordance with operation of a brake pedal of the vehicle; a first pressurizing section arranged to pressurize the wheel cylinder by operating the master cylinder independently of operation of the brake pedal; a second pressurizing section arranged to pressurize the wheel cylinder independently of operation of the master cylinder; and a control unit for controlling the first and second pressurizing sections, the control unit being configured to: determine whether a first operation request according to a physical relationship between the vehicle and an environment surrounding the vehicle is present or absent; determine whether a second operation request according to a physical behavior of the vehicle is present or absent; activate the first pressurizing section in response to determining that the first operation request is present and the second operation request is absent; activate the second pressurizing section in response to determining that the first operation request is absent and the second operation request is present; and keep the first pressurizing section activated and activate the second pressurizing section, in response to determining that the second operation request turns present under condition that the first pressurizing section is activated in response to the first operation request.

According to another aspect of the present invention, a vehicle behavior control apparatus comprises: a master cylinder arranged to pressurize a wheel cylinder of a vehicle in accordance with operation of a brake pedal of the vehicle; a first pressurizing section arranged to pressurize the wheel cylinder by operating the master cylinder independently of operation of the brake pedal; a second pressurizing section arranged to pressurize the wheel cylinder independently of operation of the master cylinder; and a control unit for controlling the first and second pressurizing sections, the control unit being configured to: perform a first control operation of pressurizing the wheel cylinder by operating the first pressurizing section; perform a second control operation of pressurizing the wheel cylinder by operating the second pressurizing section; and continue the first control operation and start the second control operation, after starting the first control operation.

According to a further aspect of the present invention, a vehicle behavior control apparatus comprises: a hydraulic circuit hydraulically connected to a wheel cylinder of a vehicle, the hydraulic circuit including: a master cylinder arranged to pressurize the wheel cylinder in accordance with operation of a brake pedal of the vehicle; a first pressurizing section for pressurizing the wheel cylinder by operating the master cylinder independently of operation of the brake pedal; a second pressurizing section for pressurizing the wheel cylinder independently of operation of the master cylinder, the second pressurizing section including a pressure supply section for supplying a hydraulic pressure independently of operation of the master cylinder; a first fluid passage hydraulically connected between the master cylinder and the wheel cylinder; a second fluid passage hydraulically connected between a first portion of the first fluid passage and a discharge port of the pressure supply section; a check valve disposed in the second fluid passage for allowing an operating fluid to flow from the discharge port of the pressure supply section to the first fluid passage, and preventing the operating fluid from flowing inversely; an outlet gate valve disposed in the first fluid passage between the master cylinder and the first portion of the first fluid passage; a third fluid passage hydraulically connected between a suction port of the pressure supply section and a second portion of the first fluid passage, the second portion being disposed between the master cylinder and the outlet gate valve; an inlet gate valve disposed in the third fluid passage for selectively allowing and inhibiting fluid communication between the master cylinder and the suction port of the pressure supply section; an inlet valve disposed in the first fluid passage between the wheel cylinder and the first portion of the first fluid passage; a fourth fluid passage hydraulically connected between the suction port of the pressure supply section and a third portion of the first fluid passage, the third portion being disposed between the inlet valve and the wheel cylinder; an outlet valve disposed in the fourth fluid passage, the outlet valve being a normally closed valve; and a reservoir disposed in the fourth fluid passage between the outlet valve and the suction port of the pressure supply section; and a control unit for controlling the hydraulic circuit, the control unit being configured to: close the outlet gate valve and open the inlet gate valve, in response to determining that the second pressurizing section is activated; open the outlet gate valve and close the inlet gate valve, in response to determining that the first pressurizing section is activated; and open the inlet gate valve, in response to determining that the second pressurizing section is activated under condition that the first pressurizing section is activated.

### BRIEF DESCRIPTION OF THE DRAWINGS

FIG. 1 is a schematic diagram showing system configuration of an automotive vehicle provided with a vehicle behavior control apparatus according to a first embodiment of the present invention.

FIG. 2 is a hydraulic circuit diagram showing a brake system of the vehicle behavior control apparatus of FIG. 1.

FIG. 3 is a schematic diagram showing a plurality of brake operation modes to be employed by the vehicle behavior control apparatus of FIG. 1, and shifts between the brake operation modes.

FIG. 4 is a flow chart showing an overall control process to be performed by the vehicle behavior control apparatus of FIG. 1.

FIG. 5 is a flow chart showing a first example of a sub process for selection of brake operation mode which is entered from the flow chart of FIG. 4.

FIG. 6 is a flow chart showing a second example of the sub process for selection of brake operation mode which is entered from the flow chart of FIG. 4.

FIG. 7 is a flow chart showing a third example of the sub process for selection of brake operation mode which is entered from the flow chart of FIG. 4.

FIG. 8 is a flow chart showing a fourth example of the sub process for selection of brake operation mode which is entered from the flow chart of FIG. 4.

FIG. 9 is a flow chart showing a sub process for computing of desired hydraulic pressures which is entered from the flow chart of FIG. 4.

FIG. 10 is a flow chart showing a sub process for identification of brake pedal operation which is entered from the flow chart of FIG. 4.

FIG. 11 is a flow chart showing a sub process for drive of an electronically-controlled brake booster which is entered from the flow chart of FIG. 4.

FIG. 12 is a flow chart showing a sub process for drive of a motor and valves which is entered from the flow chart of FIG. 4.

FIG. 13 is a time chart showing a case of operation of the vehicle behavior control apparatus of FIG. 1.

FIG. 14 is a time chart showing a case of operation of the vehicle behavior control apparatus of FIG. 1.

FIG. 15 is a time chart showing a case of operation of the vehicle behavior control apparatus of FIG. 1.

FIG. 16 is a time chart showing a case of operation of the vehicle behavior control apparatus of FIG. 1.

FIG. 17 is a time chart showing a case of operation of the vehicle behavior control apparatus of FIG. 1.

FIG. 18 is a time chart showing a case of operation of the vehicle behavior control apparatus of FIG. 1.

FIG. 19 is a time chart showing a case of operation of the vehicle behavior control apparatus of FIG. 1.

FIG. 20 is a time chart showing a case of operation of the vehicle behavior control apparatus of FIG. 1.

FIG. 21 is a time chart showing a case of operation of the vehicle behavior control apparatus of FIG. 1.

FIG. 22 is a time chart showing a case of operation of the vehicle behavior control apparatus of FIG. 1.

FIG. 23 is a hydraulic circuit diagram showing a brake system of a vehicle behavior control apparatus according to a second embodiment of the present invention.

FIG. 24 is a flow chart showing a sub process according to the second embodiment for drive of a motor and valves which is entered from the flow chart of FIG. 4.

FIG. 25 is a time chart showing a case of operation of the vehicle behavior control apparatus according to the second embodiment.

FIG. 26 is a time chart showing a case of operation of the vehicle behavior control apparatus according to the second embodiment.

FIG. 27 is a hydraulic circuit diagram showing a brake system of a vehicle behavior control apparatus according to a third embodiment of the present invention.

FIG. 28 is a flow chart showing a sub process according to the third embodiment for drive of a motor and valves which is entered from the flow chart of FIG. 4.

FIG. 29 is a time chart showing a case of operation of the vehicle behavior control apparatus according to the third embodiment.

FIG. 30 is a time chart showing a case of operation of the vehicle behavior control apparatus according to the third embodiment.

### DETAILED DESCRIPTION OF THE INVENTION

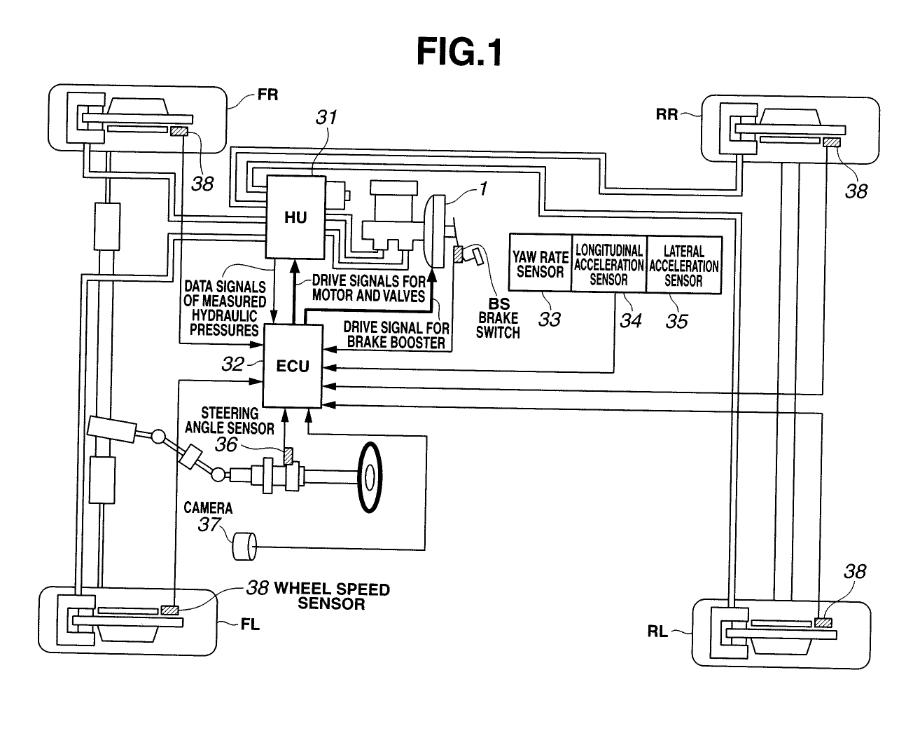

### Embodiment 1

<System Configuration of Vehicle> FIG. 1 schematically shows system configuration of an automotive vehicle provided with a vehicle behavior control apparatus or system according to a first embodiment of the present invention. The vehicle includes a front left wheel “FL” (first road wheel), a front right wheel “FR” (second road wheel), a rear left wheel “RL” (third road wheel), and a rear right wheel “RR” (fourth road wheel). The vehicle behavior control apparatus includes an electronically-controlled brake booster 1 for controlling a master cylinder pressure independently of brake pedal operation, a brake unit 31 for controlling wheel cylinder pressures for wheels FL, FR, RL and RR, and an electric control unit 32 for controlling the electronically-controlled brake booster 1 and brake unit 31 by sending command signals or control signals to them.

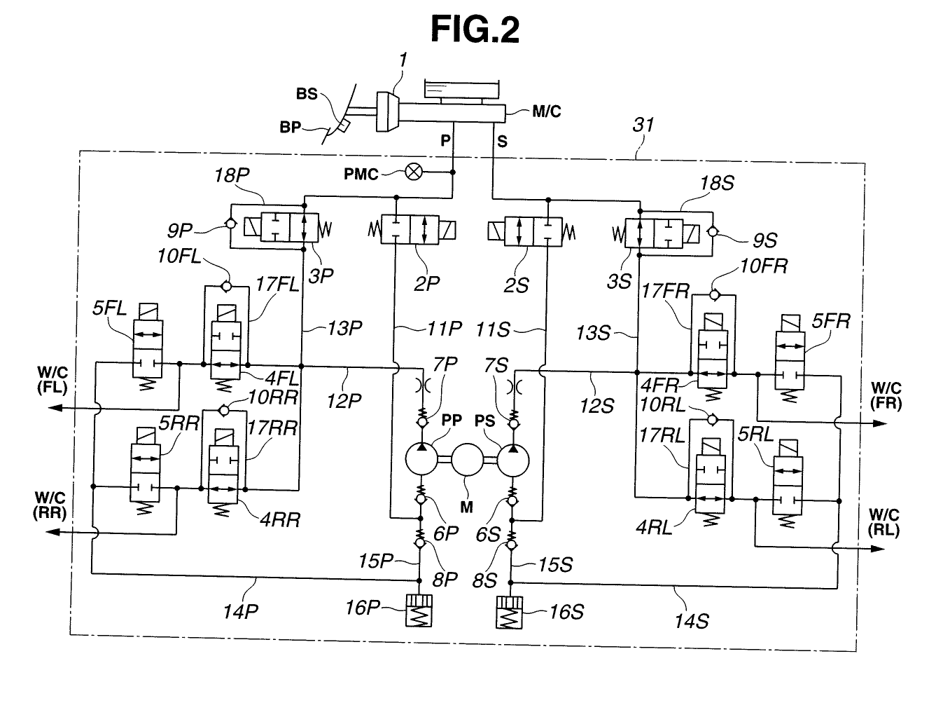

Control unit 32 is configured to receive data signals from a brake switch “BS”, a yaw rate sensor 33, a longitudinal acceleration sensor 34, a lateral acceleration sensor 35, a steering angle sensor 36, a camera or radar 37 and a wheel speed sensor 38, which are mounted on the vehicle for collecting information used to determine a physical relationship between the vehicle and an environment surrounding the vehicle, and determine a physical behavior of the vehicle. On the basis of the data signals, control unit 32 computes desired values of controlled variables, and outputs corresponding command signals to the electronically-controlled brake booster 1 and brake unit 31.

<Construction of Brake System> FIG. 2 schematically shows a brake system of the vehicle behavior control apparatus of FIG. 1. The brake system includes a hydraulic circuit of so called an X-pipe arrangement, which includes a subsystem or section “P” and a subsystem or section “S”.

The section P is hydraulically connected to a front left wheel cylinder “W/C(FL)” adapted for front left wheel FL, and a rear right wheel cylinder “W/C(RR)” adapted for rear right wheel RR. The section S is hydraulically connected to a front right wheel cylinder “W/C(FR)” adapted for front right wheel FR, and a rear left wheel cylinder “W/C(RL)” adapted for rear left wheel RL. The sections P and S include hydraulic pumps “PP” and “PS”, respectively, which are driven by a single electric motor “M”. The hydraulic pumps PP and PS may be plunger pumps or gear pumps. In general, plunger pumps are advantageous in terms of manufacturing cost, while gear pumps are advantageous in terms of smoothness and controllability. Electric motor M, and hydraulic pumps PP and PS serve as a pressure supply section for controlling the internal pressures of wheel cylinders W/C(FL), W/C(FR), W/C(RL) and W/C(RR) independently of operation of brake pedal BP.

Brake switch BS is provided at a brake pedal “BP” for measuring or identifying a state of operation of brake pedal BP. Brake pedal BP is connected to a master cylinder “M/C” through the electronically-controlled brake booster 1.

Hydraulic pumps PP and PS include intake ports which are hydraulically connected to master cylinder M/C through fluid passages 11P and 115, respectively. Inlet gate valves 2P and 2S are provided in fluid passages 11P and 11S, respectively. Inlet gate valves 2P and 2S are normally closed electromagnetic valves. A pressure sensor “PMC” is provided in a section of fluid passage 11P between master cylinder M/C and inlet gate valve 2P for measuring the internal pressure of master cylinder M/C.

A check valve 6P is provided in a section of fluid passage 11P between inlet gate valve 2P and hydraulic pump PP, for allowing a brake fluid to flow from inlet gate valve 2P to hydraulic pump PP and preventing the brake fluid from flowing inversely. Similarly, a check valve 6S is provided in a section of fluid passage 11S between inlet gate valve 2S and hydraulic pump PS, for allowing the brake fluid to flow from inlet gate valve 2S to hydraulic pump PS and preventing the brake fluid from flowing inversely.

Hydraulic pumps PP and PS are hydraulically connected to wheel cylinders W/C(FL), W/C(FR), W/C(RL) and W/C(RR) through fluid passages 12P and 12S, respectively. Inlet solenoid valves 4FL and 4RR are provided in branch sections of fluid passage 12P, and inlet solenoid valves 4FR and 4RL are provided in branch sections of fluid passage 12S. Inlet solenoid valves 4FL, 4FR, 4RL and 4RR are normally open electromagnetic valves. The opening of each inlet solenoid valve is adjusted by repeatedly fully opening and fully closing.

A check valve 7P is provided in fluid passage 12P between hydraulic pump PP and the branch point to the sections for inlet solenoid valves 4FL and 4RR, for allowing the brake fluid to flow from hydraulic pump PP to inlet solenoid valves 4FL and 4RR, and preventing the brake fluid from flowing inversely. Similarly, a check valve 7S is provided in fluid passage 12S between hydraulic pump PS and the branch point to the sections for inlet solenoid valves 4FR and 4RL, for allowing the brake fluid to flow from hydraulic pump PS to inlet solenoid valves 4FR and 4RL, and preventing the brake fluid from flowing inversely.

Fluid passages 17FL, 17FR, 17RL and 17RR are provided in fluid passages 12P and 12S, bypassing the inlet solenoid valves 4FL, 4FR, 4RL and 4RR, respectively. Check valves 10FL, 10FR, 10RL and 10RR are provided in fluid passages 17FL, 17FR, 17RL and 17RR, respectively, for allowing the brake fluid to flow in directions from wheel cylinders W/C(FL), W/C(FR), W/C(RL) and W/C(RR) to hydraulic pumps PP and PS, and preventing the brake fluid from flowing inversely.

Fluid passages 12P and 12S are hydraulically connected to master cylinder M/C through fluid passages 13P and 13S, respectively. Fluid passages 13P and 13S are hydraulically connected to the respective branch points of fluid passages 12P and 12S between hydraulic pumps PP and PS and inlet solenoid valves 4FL, 4FR, 4RL and 4RR. Outlet gate valves 3P and 3S are normally open electromagnetic valves, and provided in fluid passages 13P and 13S, respectively.

Fluid passages 18P and 18S are provided in fluid passages 13P and 13S, bypassing the outlet gate valves 3P and 3S, respectively. A check valve 9P is provided in fluid passage 18P for allowing the brake fluid to flow in directions from master cylinder M/C to wheel cylinders W/C(FL) and W/C(RR), and preventing the brake fluid from flowing inversely. Similarly, a check valve 9S is provided in fluid passage 18S for allowing the brake fluid to flow in directions from master cylinder M/C to wheel cylinders W/C(FR) and W/C(RL), and preventing the brake fluid from flowing inversely.

An internal reservoir 16P is hydraulically connected to a suction port of hydraulic pump PP through a fluid passage 15P. A check valve 8P is provided in fluid passage 15P between internal reservoir 16P and hydraulic pump PP for allowing the brake fluid to flow in a direction from internal reservoir 16P to hydraulic pump PP, and preventing the brake fluid from flowing inversely. Similarly, an internal reservoir 16S is hydraulically connected to a suction port of hydraulic pump PS through a fluid passage 15S. A check valve 8S is provided in fluid passage 15S between internal reservoir 16S and hydraulic pump PS for allowing the brake fluid to flow in a direction from internal reservoir 16S to hydraulic pump PS, and preventing the brake fluid from flowing inversely.

Fluid passages 15P and 15S are hydraulically connected to wheel cylinders W/C(FL), W/C(FR), W/C(RL) and W/C(RR) through fluid passages 14P and 14S, respectively. Fluid passage 14P is hydraulically connected to a section of fluid passage 15P between check valve 8P and internal reservoir 16P. Fluid passage 14S is hydraulically connected to a section of fluid passage 15S between check valve 8S and internal reservoir 16S. Outlet solenoid valves 5FL, 5FR, 5RL and 5RR are normally closed electromagnetic valves, and provided in branch sections of fluid passages 14P and 14S. The opening of each outlet solenoid valve is adjusted by repeatedly fully opening and fully closing.

The thus-constructed hydraulic circuit includes a first hydraulic system or first pressurizing section (electronically-controlled brake booster 1, etc.) for pressurizing wheel cylinders by operating a master cylinder, and a second hydraulic system or second pressurizing section (electric motor M, hydraulic pumps PP and PS, etc.) for pressurizing the wheel cylinders independently of operation of the master cylinder.

Inlet solenoid valves 4FL, 4FR, 4RL and 4RR serve as first, second, third and fourth pressure-increasing valves hydraulically connected to first, second, third and fourth wheel cylinders, respectively, for allowing respective ones of the first, second, third and fourth wheel cylinders to be pressurized. Outlet solenoid valves 5FL, 5FR, 5RL and 5RR serve as first, second, third and fourth pressure-reducing valves hydraulically connected to the first, second, third and fourth wheel cylinders, respectively, for allowing respective ones of the first, second, third and fourth wheel cylinders to be depressurized.

In the flow charts and time charts, the names of the valves are denoted as follows. Inlet gate valves 2P and 2S are denoted respectively by “G/V-IN[P]” and “G/V-IN[S]”, or collectively by “G/V-IN”. Outlet gate valves 3P and 3S are denoted respectively by “G/V-OUT[P]” and “G/V-OUT[S]”, or collectively by “G/V-OUT”. Inlet solenoid valves 4FL, 4FR, 4RL and 4RR are denoted respectively by “Sol/V-IN[FL]”, “Sol/V-IN[FR]”, “Sol/V-IN[RL]” and “Sol/V-IN[RR]”, or collectively by “Sol/V-IN”. Outlet solenoid valves 5FL, 5FR, 5RL and 5RR are denoted respectively by “Sol/V-OUT[FL]”, “Sol/V-OUT[FR]”, “Sol/V-OUT[RL]” and “Sol/V-OUT[RR]”, or collectively by “Sol/V-OUT”.

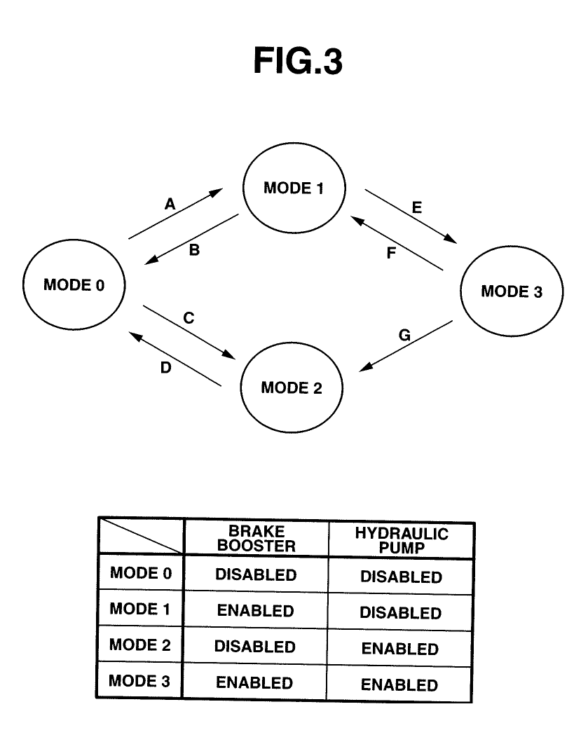

FIG. 3 schematically shows a plurality of brake operation modes to be employed by the vehicle behavior control apparatus of FIG. 1, and shifts between the brake operation modes.

It is to be understood from the foregoing description that the hydraulic circuit includes a first pressurizing function (by electronically-controlled brake booster 1) of pressurizing the wheel cylinders by operating the master cylinder, and a second pressurizing function (by hydraulic pumps PP and PS) of pressurizing the wheel cylinders independently of operation of the master cylinder.

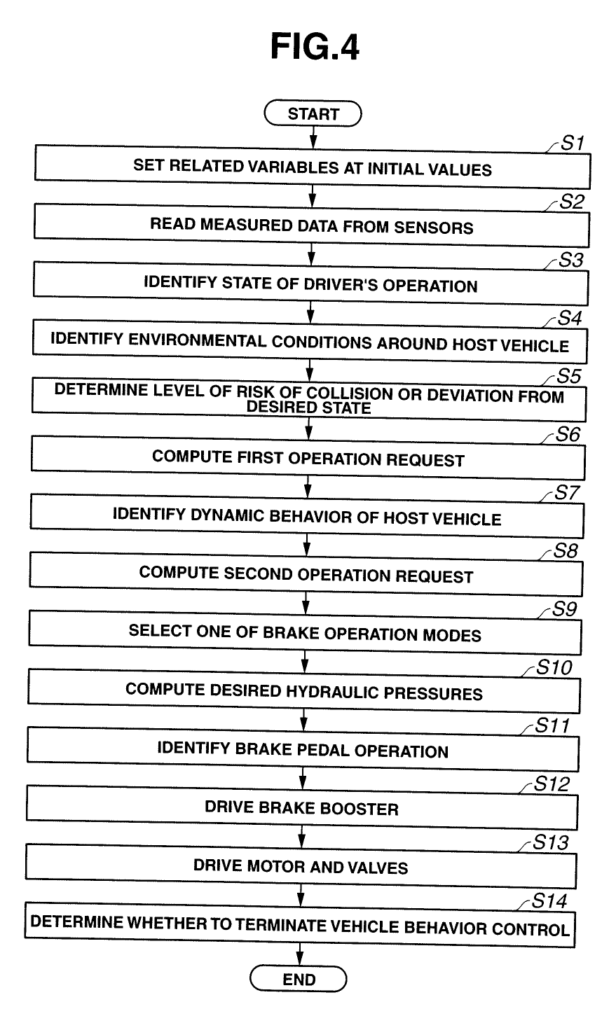

The brake operation modes include modes “0”, “1”, “2”, and “3”. The mode 0 is one which is selected initially at Step S1 in a flow chart of FIG. 4 described below, and is employed under normal operating conditions. When in the mode 0, the operation of electronically-controlled brake booster 1 is disabled or inhibited, and the operation of electric motor M (hydraulic pumps PP and PS) is disabled or inhibited. When in the mode 1, the operation of electronically-controlled brake booster 1 is enabled or allowed, and the operation of electric motor M (hydraulic pumps PP and PS) is disabled or inhibited. When in the mode 2, the operation of electronically-controlled brake booster 1 is disabled or inhibited, and the operation of electric motor M (hydraulic pumps PP and PS) is enabled or allowed. When in the mode 3, the operation of electronically-controlled brake booster 1 is enabled or allowed, and the operation of electric motor M (hydraulic pumps PP and PS) is enabled or allowed.

A shift from the mode 0 to the mode 1 occurs, when a condition “A” is satisfied in which a first operation request based on a physical relationship between the host vehicle and an environment surrounding the vehicle turns effective or present when in the mode 0. A condition “B” for a shift from the mode 1 to the mode 0 is one in which the first operation request turns ineffective or absent when in the mode 1.

A condition “C” for a shift from the mode 0 to the mode 2 is one in which a second operation request based on a physical behavior of the host vehicle turns effective or present when in the mode 0. A condition “D” for a shift from the mode 2 to the mode 0 is one in which the second operation request turns ineffective or absent when in the mode 2.

A condition “E” for a shift from the mode 1 to the mode 3 is one in which the second operation request turns effective or present when in the mode 1. A condition “F” for a shift from the mode 3 to the mode 1 is one in which the second operation request turns ineffective or absent when in the mode 3.

A condition “G” for a shift from the mode 3 to the mode 2 is one in which the first operation request turns ineffective or absent when in the mode 3. A shift from the mode 2 to the mode 3 is inhibited.

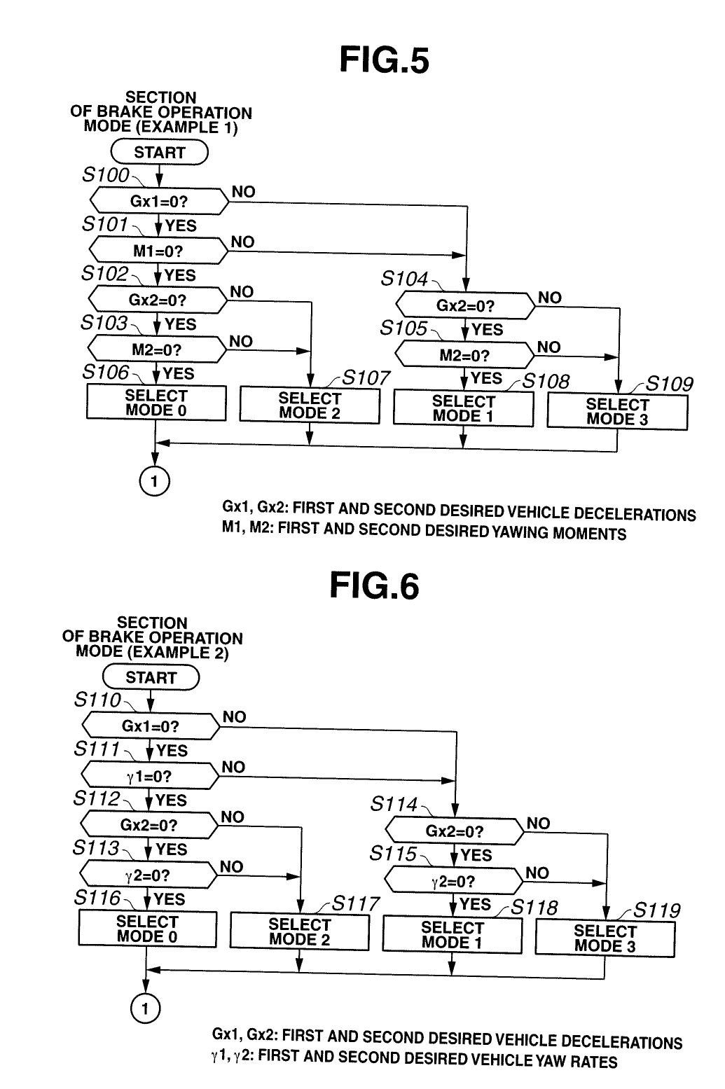

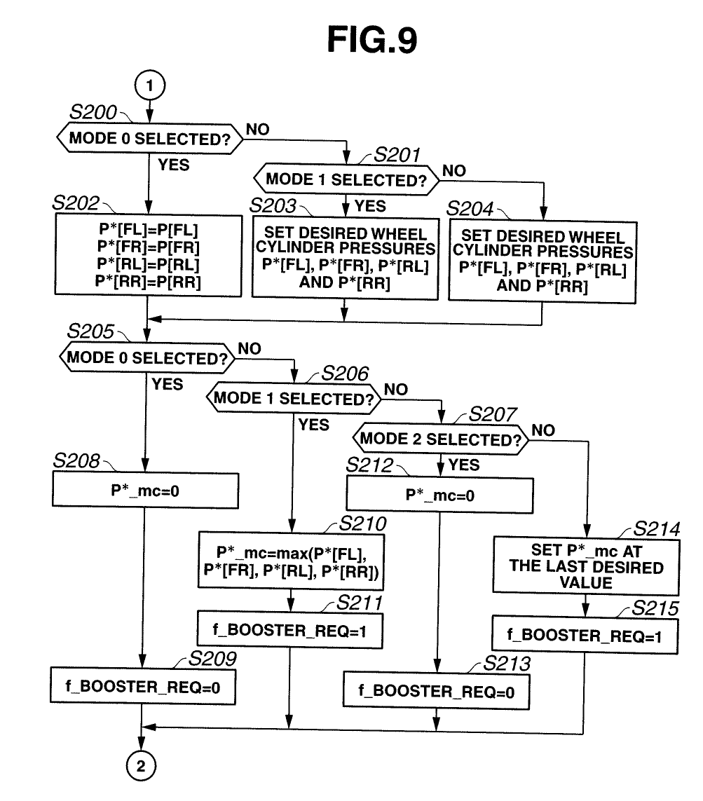

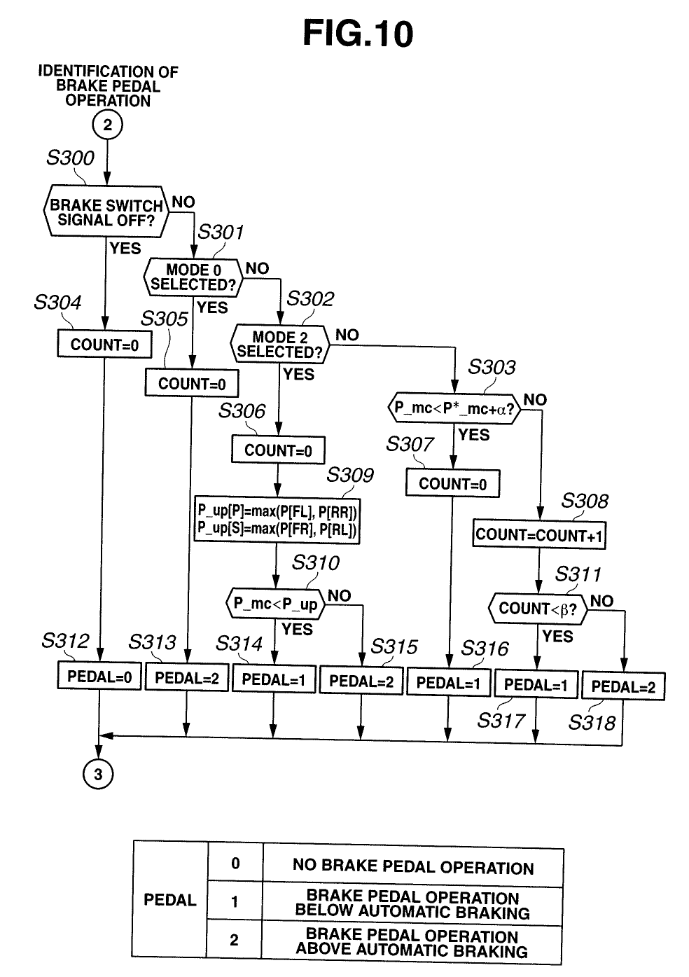

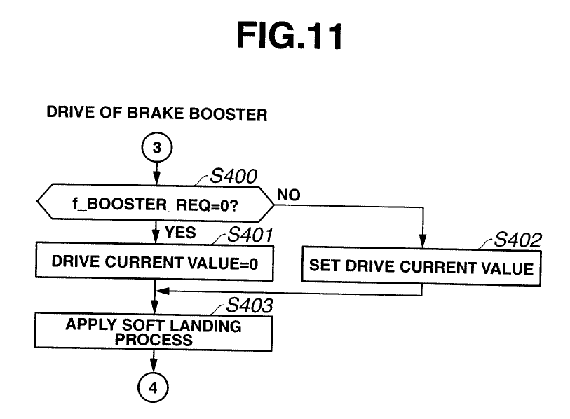

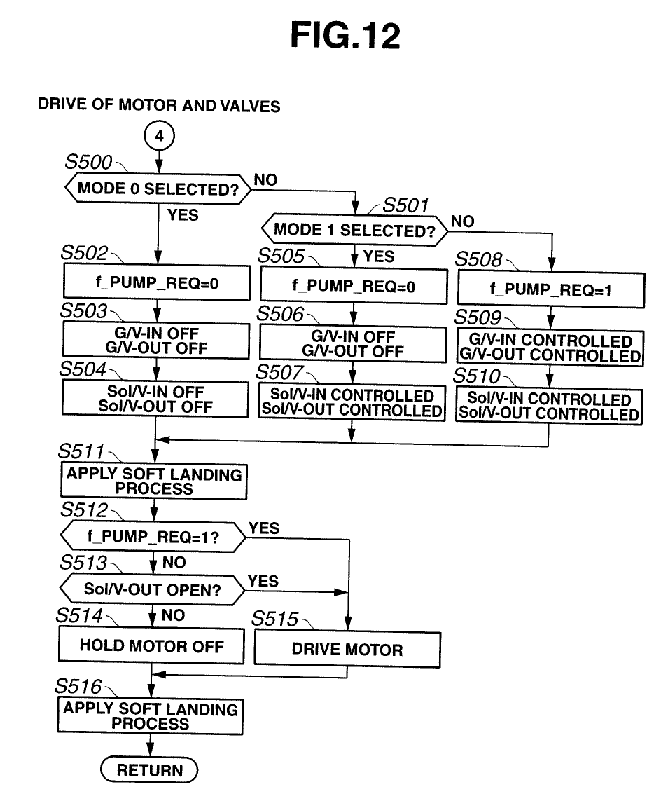

FIG. 4 shows an overall control process to be performed by the vehicle behavior control apparatus of FIG. 1. Control unit 32 is configured to operate as follows. At Step S1, control unit 32 sets related variables to predetermined initial values. The variables include flags employed in the control process, a timer value, coefficients employed to compute a model of the host vehicle. At Step S2, control unit 32 reads measured data from the sensors. At Step S3, control unit 32 identifies the state of driver's operation. At Step S4, control unit 32 identifies environmental conditions around the host vehicle. Specifically, control unit 32 recognizes vehicles, pedestrians, guide rails, and road signs, which are present ahead of, behind of, or on sides of the host vehicle, and computes a position and speed of each of them relative to the host vehicle. At Step S5, control unit 32 determines a level of risk of collision or deviation from a desired safe state, on the basis of the identified state of driver's operation and the identified environmental conditions. At Step S6, control unit 32 computes a first operation request suitable for avoiding the risk or reducing the level of risk. At Step S7, control unit 32 identifies a dynamic behavior of the host vehicle such as a tendency of oversteer or understeer. At Step S8, control unit 32 computes a second operation request suitable for stabilizing the vehicle behavior. At Step S9, control unit 32 selects one of the brake operation modes according to the first and second operation requests computed at Steps S6 and S8. Step S9 is described in detail below with reference to FIGS. 5 to 8. At Step S10, control unit 32 computes desired wheel cylinder pressures P*(FL), P*(FR), P*(RL) and P*(RR), and a desired master cylinder pressure P*_mc (to be attained by electronically-controlled brake booster 1) on the basis of the first and second operation requests. Step S10 is described in detail below with reference to FIG. 9. At Step S11, control unit 32 identifies driver's operation of the brake pedal. Step S11 is described in detail below with reference to FIG. 10. At Step S12, control unit 32 drives electronically-controlled brake booster 1 by outputting a command signal to electronically-controlled brake booster 1 according to the desired master cylinder pressure P*_mc. Step S12 is described in detail below with reference to FIG. 11. At Step S13, control unit 32 drives electric motor M and the valves by outputting command signals according to the desired wheel cylinder pressures P*(FL), P*(FR), P*(RL) and P*(RR). Step S13 is described in detail below with reference to FIG. 12. At Step S14, control unit 32 determines whether to terminate the this control process.

<Selection of Brake Operation Mode> FIGS. 5 to 8 show four examples of a sub process for selection of brake operation mode which is entered from Step S9 of the flow chart of FIG. 4. Each of the first and second operation requests includes a request to change a longitudinal movement of the host vehicle and a request to change a yaw movement of the host vehicle. Accordingly, the sub process deals with a parameter related to the longitudinal movement of the host vehicle, and a parameter related to the lateral movement (yaw movement) of the host vehicle. The former parameter is a deceleration of the host vehicle, G (m/s²), or a braking force applied to the host vehicle, F (N). The latter parameter is a yaw rate of the host vehicle, γ (rad/s), or a yawing moment applied to the host vehicle, M (Nm).

The vehicle yaw rate γ and the vehicle deceleration G are measured directly by yaw rate sensor 33, longitudinal acceleration sensor 34 and lateral acceleration sensor 35, whereas the yawing moment M (=I·dγ/dt, where I represents a yaw moment of inertia of the host vehicle (kg·m²)) and the braking force F (=m·G, where m represents a mass of the host vehicle (kg)) are identified indirectly through computing. The sub process is characterized by which combination of the parameters is used.

FIG. 5 shows an example of selection of brake operation mode in which each of the first and second operation requests computed at Steps S6 and S8 includes a desired vehicle deceleration Gx and a desired yawing moment M. In this example, the vehicle deceleration G is measured directly by the sensors, whereas the yawing moment M is not directly measured. The first operation request includes a first desired vehicle deceleration Gx1 and a first desired yawing moment M1. The second operation request includes a second desired vehicle deceleration Gx2 and a second desired yawing moment M2. Control unit 32 is configured to operate as follows.

At Step S100, control unit 32 determines whether or not the first desired vehicle deceleration Gx1 is equal to zero. When the answer to Step S100 is affirmative (YES), then control unit 32 proceeds to Step S101. On the other hand, when the answer to Step S100 is negative (NO), then control unit 32 proceeds to Step S104.

At Step S101, control unit 32 determines whether or not the first desired yawing moment M1 is equal to zero. When the answer to Step S101 is YES, then control unit 32 proceeds to Step S102. On the other hand, when the answer to Step S101 is NO, then control unit 32 proceeds to Step S104.

At Step S102, control unit 32 determines whether or not the second desired vehicle deceleration Gx2 is equal to zero. When the answer to Step S102 is YES, then control unit 32 proceeds to Step S103. On the other hand, when the answer to Step S102 is NO, then control unit 32 proceeds to Step S107, at which control unit 32 selects the mode 2 in which the drive of electronically-controlled brake booster 1 is disabled and the drive of hydraulic pumps PP and PS is enabled.

At Step S103, control unit 32 determines whether or not the second desired yawing moment M2 is equal to zero. When the answer to Step S103 is YES, then control unit 32 proceeds to Step S106, at which control unit 32 selects the mode 0 in which the drive of electronically-controlled brake booster 1 is disabled and the drive of hydraulic pumps PP and PS is disabled. On the other hand, when the answer to Step S103 is NO, then control unit 32 proceeds to Step S107.

At Step S104, control unit 32 determines whether or not the second desired vehicle deceleration Gx2 is equal to zero. When the answer to Step S104 is YES, then control unit 32 proceeds to Step S105. On the other hand, when the answer to Step S104 is NO, then control unit 32 proceeds to Step S109, at which control unit 32 selects the mode 3 in which the drive of electronically-controlled brake booster 1 is enabled and the drive of hydraulic pumps PP and PS is enabled.

At Step S105, control unit 32 determines whether or not the second desired yawing moment M2 is equal to zero. When the answer to Step S105 is YES, then control unit 32 proceeds to Step S108, at which control unit 32 selects the mode 1 in which the drive of electronically-controlled brake booster 1 is enabled and the drive of hydraulic pumps PP and PS is disabled. On the other hand, when the answer to Step S105 is NO, then control unit 32 proceeds to Step S109.

After the selection is done at Steps S106 to S109, control unit 32 proceeds to Step S200 shown in FIG. 9 and described in detail below. Since the vehicle deceleration G is used as a parameter related to the longitudinal movement of the host vehicle, and is easily and directly measured, the sub process shown in FIG. 5 allows the control of the longitudinal movement of the host vehicle to be performed with enhanced accuracy.

FIG. 6 shows an example of selection of brake operation mode in which each of the first and second operation requests computed at Steps S6 and S8 includes a desired vehicle deceleration Gx and a desired vehicle yaw rate γ. In this example, both of the vehicle deceleration G and the vehicle yaw rate γ are measured directly by the sensors. The first operation request includes a first desired vehicle deceleration Gx1 and a first desired vehicle yaw rate γ1. The second operation request includes a second desired vehicle deceleration Gx2 and a second desired vehicle yaw rate γ2. Control unit 32 is configured to operate as follows.

At Step S110, control unit 32 determines whether or not the first desired vehicle deceleration Gx1 is equal to zero. When the answer to Step S110 is YES, then control unit 32 proceeds to Step S111. On the other hand, when the answer to Step S110 is NO, then control unit 32 proceeds to Step S114.

At Step S111, control unit 32 determines whether or not the first desired vehicle yaw rate γ1 is equal to zero. When the answer to Step S111 is YES, then control unit 32 proceeds to Step S112. On the other hand, when the answer to Step S111 is NO, then control unit 32 proceeds to Step S114.

At Step S112, control unit 32 determines whether or not the second desired vehicle deceleration Gx2 is equal to zero. When the answer to Step S112 is YES, then control unit 32 proceeds to Step S113. On the other hand, when the answer to Step S112 is NO, then control unit 32 proceeds to Step S117, at which control unit 32 selects the mode 2 in which the drive of electronically-controlled brake booster 1 is disabled and the drive of hydraulic pumps PP and PS is enabled.

At Step S113, control unit 32 determines whether or not the second desired vehicle yaw rate γ2 is equal to zero. When the answer to Step S113 is YES, then control unit 32 proceeds to Step S116, at which control unit 32 selects the mode 0 in which the drive of electronically-controlled brake booster 1 is disabled and the drive of hydraulic pumps PP and PS is disabled. On the other hand, when the answer to Step S113 is NO, then control unit 32 proceeds to Step S117.

At Step S114, control unit 32 determines whether or not the second desired vehicle deceleration Gx2 is equal to zero. When the answer to Step S114 is YES, then control unit 32 proceeds to Step S115. On the other hand, when the answer to Step S114 is NO, then control unit 32 proceeds to Step S119, at which control unit 32 selects the mode 3 in which the drive of electronically-controlled brake booster 1 is enabled and the drive of hydraulic pumps PP and PS is enabled.

At Step S115, control unit 32 determines whether or not the second desired vehicle yaw rate γ2 is equal to zero. When the answer to Step S115 is YES, then control unit 32 proceeds to Step S118, at which control unit 32 selects the mode 1 in which the drive of electronically-controlled brake booster 1 is enabled and the drive of hydraulic pumps PP and PS is disabled. On the other hand, when the answer to Step S115 is NO, then control unit 32 proceeds to Step S119.

After the selection is done at Steps S116 to S119, control unit 32 proceeds to Step S200 shown in FIG. 9 and described in detail below. Since the vehicle deceleration G and the vehicle yaw rate γ are used as parameters related to the longitudinal and yaw movements of the host vehicle, and are easily and directly measured, the sub process shown in FIG. 6 allows the control of the longitudinal and yaw movements of the host vehicle to be performed with enhanced accuracy.

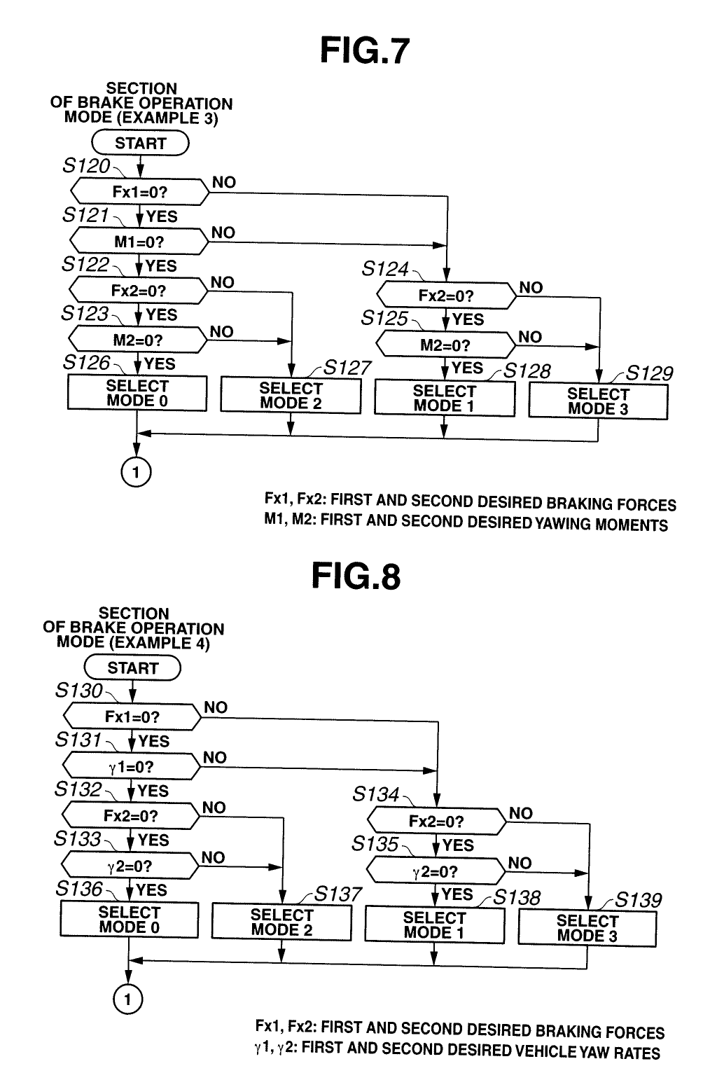

FIG. 7 shows an example of selection of brake operation mode in which each of the first and second operation requests computed at Steps S6 and S8 includes a desired braking force Fx and a desired yawing moment M.

In this example, both of the braking force F and yawing moment M are not directly measured. The first operation request includes a first desired braking force Fx1 and a first desired yawing moment M1. The second operation request includes a second desired braking force Fx2 and a second desired yawing moment M2. Control unit 32 is configured to operate as follows.

At Step S120, control unit 32 determines whether or not the first desired braking force Fx1 is equal to zero. When the answer to Step S120 is YES, then control unit 32 proceeds to Step S121. On the other hand, when the answer to Step S120 is NO, then control unit 32 proceeds to Step S124.

At Step S121, control unit 32 determines whether or not the first desired yawing moment M1 is equal to zero. When the answer to Step S121 is YES, then control unit 32 proceeds to Step S122. On the other hand, when the answer to Step S121 is NO, then control unit 32 proceeds to Step S124.

At Step S122, control unit 32 determines whether or not the second desired braking force Fx2 is equal to zero. When the answer to Step S122 is YES, then control unit 32 proceeds to Step S123. On the other hand, when the answer to Step S122 is NO, then control unit 32 proceeds to Step S127, at which control unit 32 selects the mode 2 in which the drive of electronically-controlled brake booster 1 is disabled and the drive of hydraulic pumps PP and PS is enabled.

At Step S123, control unit 32 determines whether or not the second desired yawing moment M2 is equal to zero. When the answer to Step S123 is YES, then control unit 32 proceeds to Step S126, at which control unit 32 selects the mode 0 in which the drive of electronically-controlled brake booster 1 is disabled and the drive of hydraulic pumps PP and PS is disabled. On the other hand, when the answer to Step S123 is NO, then control unit 32 proceeds to Step S127.

At Step S124, control unit 32 determines whether or not the second desired braking force Fx2 is equal to zero. When the answer to Step S124 is YES, then control unit 32 proceeds to Step S125. On the other hand, when the answer to Step S124 is NO, then control unit 32 proceeds to Step S129, at which control unit 32 selects the mode 3 in which the drive of electronically-controlled brake booster 1 is enabled and the drive of hydraulic pumps PP and PS is enabled.

At Step S125, control unit 32 determines whether or not the second desired yawing moment M2 is equal to zero. When the answer to Step S125 is YES, then control unit 32 proceeds to Step S128, at which control unit 32 selects the mode 1 in which the drive of electronically-controlled brake booster 1 is enabled and the drive of hydraulic pumps PP and PS is disabled. On the other hand, when the answer to Step S125 is NO, then control unit 32 proceeds to Step S129.

After the selection is done at Steps S126 to S129, control unit 32 proceeds to Step S200 shown in FIG. 9 and described in detail below. In the sub process shown in FIG. 7, the braking force F and yawing moment M are not measured directly by the sensors. If the control of movement of the host vehicle is implemented by a feedback control system in which the sensed data is converted, then such a feedback control system may require a high computing load, and accordingly, may cause a delay of response. Accordingly, in the case of the sub process shown in FIG. 7, the control system may be an open-loop system in order to suitably implement the control of movement of the host vehicle.

FIG. 8 shows an example of selection of brake operation mode in which each of the first and second operation requests computed at Steps S6 and S8 includes a desired braking force Fx and a desired vehicle yaw rate γ. In this example, the braking force F is not directly measured and the vehicle yaw rate γ is measured directly by the sensors. The first operation request includes a first desired braking force Fx1 and a first desired vehicle yaw rate γ1. The second operation request includes a second desired braking force Fx2 and a second desired vehicle yaw rate γ2. Control unit 32 is configured to operate as follows.

At Step S130, control unit 32 determines whether or not the first desired braking force Fx1 is equal to zero. When the answer to Step S130 is YES, then control unit 32 proceeds to Step S131. On the other hand, when the answer to Step S130 is NO, then control unit 32 proceeds to Step S134.

At Step S131, control unit 32 determines whether or not the first desired vehicle yaw rate γ1 is equal to zero. When the answer to Step S131 is YES, then control unit 32 proceeds to Step S132. On the other hand, when the answer to Step S131 is NO, then control unit 32 proceeds to Step S134.

At Step S132, control unit 32 determines whether or not the second desired braking force Fx2 is equal to zero. When the answer to Step S132 is YES, then control unit 32 proceeds to Step S133. On the other hand, when the answer to Step S132 is NO, then control unit 32 proceeds to Step S137, at which control unit 32 selects the mode 2 in which the drive of electronically-controlled brake booster 1 is disabled and the drive of hydraulic pumps PP and PS is enabled.

At Step S133, control unit 32 determines whether or not the second desired vehicle yaw rate γ2 is equal to zero. When the answer to Step S133 is YES, then control unit 32 proceeds to Step S136, at which control unit 32 selects the mode 0 in which the drive of electronically-controlled brake booster 1 is disabled and the drive of hydraulic pumps PP and PS is disabled. On the other hand, when the answer to Step S133 is NO, then control unit 32 proceeds to Step S137.

At Step S134, control unit 32 determines whether or not the second desired braking force Fx2 is equal to zero. When the answer to Step S134 is YES, then control unit 32 proceeds to Step S135. On the other hand, when the answer to Step S134 is NO, then control unit 32 proceeds to Step S139, at which control unit 32 selects the mode 3 in which the drive of electronically-controlled brake booster 1 is enabled and the drive of hydraulic pumps PP and PS is enabled.

At Step S135, control unit 32 determines whether or not the second desired vehicle yaw rate γ2 is equal to zero. When the answer to Step S135 is YES, then control unit 32 proceeds to Step S138, at which control unit 32 selects the mode 1 in which the drive of electronically-controlled brake booster 1 is enabled and the drive of hydraulic pumps PP and PS is disabled. On the other hand, when the answer to Step S135 is NO, then control unit 32 proceeds to Step S139.

After the selection is done at Steps S136 to S139, control unit 32 proceeds to Step S200 shown in FIG. 9 and described in detail below. Since the vehicle yaw rate γ is used as a parameter related to the yaw movement of the host vehicle, and is easily and directly measured, the sub process shown in FIG. 8 allows the control of the yaw movement of the host vehicle to be performed with enhanced accuracy.

<Setting of Desired Hydraulic Pressures> FIG. 9 shows a sub process for computing of desired hydraulic pressures which is entered from Step S10 of the flow chart of FIG. 4. Control unit 32 is configured to operate as follows.

At Step S200, control unit 32 determines whether or not the mode 0 is currently selected. When the answer to Step S200 is YES, then control unit 32 proceeds to Step S202, at which control unit 32 sets the desired wheel cylinder pressures P*(FL), P*(FR), P*(RL) and P*(RR) to the measured wheel cylinder pressures P(FL), P(FR), P(RL) and P(RR), because the mode 0 requires no active control of dynamic vehicle behavior, and then proceeds to Step S205. On the other hand, when the answer to Step S200 is NO, then control unit 32 proceeds to Step S201.

At Step S201, control unit 32 determines whether or not the mode 1 is currently selected. When the answer to Step S201 is YES, then control unit 32 proceeds to Step S203, at which control unit 32 computes desired braking forces of wheels FL, FR, RL and RR so as to achieve the first operation request computed at Step S6, and converts the desired braking forces into the desired wheel cylinder pressures P*(FL), P*(FR), P*(RL) and P*(RR), and then proceeds to Step S205. On the other hand, when the answer to Step S201 is NO, then control unit 32 proceeds to Step S204, at which control unit 32 computes the desired braking forces of wheels FL, FR, RL and RR so as to achieve the first and second operation requests computed at Steps S6 and S8, and converts the desired braking forces into the desired wheel cylinder pressures P*(FL), P*(FR), P*(RL) and P*(RR), and then proceeds to Step S205.

At Step S205, control unit 32 determines whether or not the mode 0 is currently selected. When the answer to Step S205 is YES, then control unit 32 proceeds to Step S208, at which control unit 32 sets the desired master cylinder pressure P*_mc to zero, because the mode 0 requires no active control of dynamic vehicle behavior, and then proceeds to Step S209, at which control unit 32 sets a booster request flag “f_BOOSER_REQ” to zero. On the other hand, when the answer to Step S205 is NO, then control unit 32 proceeds to Step S206.

At Step S206, control unit 32 determines whether or not the mode 1 is currently selected. When the answer to Step S206 is YES, then control unit 32 proceeds to Step S210, at which control unit 32 sets the desired master cylinder pressure P*_mc to the maximum one of the desired wheel cylinder pressures P*(FL), P*(FR), P*(RL) and P*(RR) because the mode 1 employs the electronically-controlled brake booster 1 for active control of dynamic vehicle behavior, and then proceeds to Step S211, at which control unit 32 sets the booster request flag f_BOOSER_REQ to 1. On the other hand, when the answer to Step S206 is NO, then control unit 32 proceeds to Step S207.

At Step S207, control unit 32 determines whether or not the mode 2 is currently selected. When the answer to Step S207 is YES, then control unit 32 proceeds to Step S208, at which control unit 32 sets the desired master cylinder pressure P*_mc to zero, because the mode 2 inhibits the drive of the electronically-controlled brake booster 1, and then proceeds to Step S213, at which control unit 32 sets the booster request flag f_BOOSER_REQ to zero. On the other hand, when the answer to Step S207 is NO, then control unit 32 proceeds to Step S214, at which control unit 32 sets the desired master cylinder pressure P*_mc to the last value of the desired master cylinder pressure P*_mc, and then proceeds to Step S215, at which control unit 32 sets the booster request flag f_BOOSER_REQ to 1.

After Steps S209, S211, S213 and S215, control unit 32 proceeds to Step S300 shown in FIG. 10 and described in detail below.

<Identification of Brake Pedal Operation> FIG. 10 shows a sub process for identification of brake pedal operation which is entered from Step S11 of the flow chart of FIG. 4. A brake pedal operation mode number “PEDAL” is used in this sub process. When the brake pedal operation mode number PEDAL is equal to zero, it indicates a condition in which the driver performs no brake pedal operation. When the brake pedal operation mode number PEDAL is equal to 1, it indicates a condition in which the brake pedal operation by the driver is below the automatic braking by the vehicle behavior control apparatus. When the brake pedal operation mode number PEDAL is equal to 2, it indicates a condition in which the brake pedal operation by the driver is above the automatic braking by the vehicle behavior control apparatus. Control unit 32 is configured to operate as follows.

At Step S300, control unit 32 determines whether or not brake switch BS is off. When the answer to Step S300 is YES, then control unit 32 proceeds to Step S304, at which control unit 32 resets a counter value “COUNT” to zero, and then proceeds to Step S312, at which control unit 32 sets the brake pedal operation mode number PEDAL to zero. The counter value COUNT is used for identification of brake pedal operation, and described in detail below. On the other hand, when the answer to Step S300 is NO, then control unit 32 proceeds to Step S301.

At Step S301, control unit 32 determines whether or not the mode 0 is currently selected. When the answer to Step S301 is YES, then control unit 32 proceeds to Step S305, at which control unit 32 resets the counter value COUNT to zero, and then proceeds to Step S313, at which control unit 32 sets the brake pedal operation mode number PEDAL to 2. On the other hand, when the answer to Step S301 is NO, then control unit 32 proceeds to Step S302.

At Step S302, control unit 32 determines whether or not the mode 2 is currently selected. When the answer to Step S302 is YES, then control unit 32 proceeds to Step S306, at which control unit 32 resets the counter value COUNT to zero, then proceeds to Step S309, at which control unit 32 computes pump discharge pressures P_up(P) and P_up(S), and then proceeds to Step S310. The pump discharge pressure P_up(P) is set to the maximum one of the measured front left and rear right wheel cylinder pressures P(FL) and P(RR), and the pump discharge pressure P_up(S) is set to the maximum one of the measured front right and rear left wheel cylinder pressures P(FR) and P(RL). On the other hand, when the answer to Step S302 is NO, then control unit 32 proceeds to Step S303.

At Step S310, control unit 32 determines whether or not the master cylinder pressure P_mc is below the pump discharge pressures P_up(P) and P_up(S). When the answer to Step S310 is YES, that is, when the brake pedal operation by the driver is below the controlled hydraulic pressures, then control unit 32 proceeds to Step S314, at which control unit 32 sets the brake pedal operation mode number PEDAL to 1. On the other hand, when the answer to Step S310 is NO, that is, when the brake pedal operation by the driver is above the controlled hydraulic pressures (P_mc≧P_up), then control unit 32 proceeds to Step S315, at which control unit 32 sets the brake pedal operation mode number PEDAL to 2.

At Step S303, control unit 32 determines whether or not the desired master cylinder pressure P*_mc is higher by a predetermined reference value α than the master cylinder pressure P_mc. When the answer to Step S303 is YES, that is, when the brake pedal operation by the driver is below a controlled hydraulic pressure by electronically-controlled brake booster 1, then control unit 32 proceeds to Step S307, at which control unit 32 resets the counter value COUNT to zero, and then proceeds to Step S316, at which control unit 32 sets the brake pedal operation mode number PEDAL to 1. On the other hand, when the answer to Step S303 is NO, that is, when it is possible that the brake pedal operation by the driver is above the controlled hydraulic pressure (P_mc≧P*_mc+a), then control unit 32 proceeds to Step S308, at which control unit 32 increments the counter value COUNT by 1, and then proceeds to Step S311.

At Step S311, control unit 32 determines whether or not the counter value COUNT is smaller than a predetermined reference period of time β. The electronically-controlled brake booster 1 is constructed to generate the master cylinder pressure P_mc according to the higher one of the driver's brake pedal operation and the controlled hydraulic pressure. This results in a difficulty of identifying the driver's brake pedal operation on the basis of the master cylinder pressure P_mc. This is the reason why the counter value COUNT is used. When the answer to Step S311 is YES, then control unit 32 proceeds to Step S317, at which control unit 32 sets the brake pedal operation mode number PEDAL to 1. On the other hand, when the answer to Step S311 is NO, then control unit 32 proceeds to Step S318, at which control unit 32 sets the brake pedal operation mode number PEDAL to 2.

After the setting of the brake pedal operation mode number PEDAL at Steps S312 to S318, control unit 32 proceeds to Step S400 in the flow chart of FIG. 11.

<Drive of Brake Booster> FIG. 11 shows a sub process for drive of electronically-controlled brake booster 1 which is entered from Step S12 of the flow chart of FIG. 4. Control unit 32 is configured to operate as follows.

At Step S400, control unit 32 determines whether or not the booster request flag f_BOOSER_REQ is equal to zero. When the answer to Step S400 is YES, then control unit 32 proceeds to Step S401, at which control unit 32 sets a drive current value for electronically-controlled brake booster 1 to zero. On the other hand, when the answer to Step S400 is NO, that is, when the booster request flag f_BOOSER_REQ is equal to 1, then control unit 32 proceeds to Step S402, at which control unit 32 sets the drive current value on the basis of the desired master cylinder pressure P*_mc. After the setting of the drive current value at Steps S401 and S402, control unit 32 proceeds to Step S403, at which control unit 32 applies a soft landing process to the drive current value, and then proceeds to Step S500 in the flow chart of FIG. 12. The drive of electronically-controlled brake booster 1 may be implemented by a method disclosed in Japanese Patent Application Publication No. 2002-255024. The soft landing process is to modify a command value that is set to change toward a local maximum or minimum, so that the modified command value approaches the local maximum or minimum at a reduced rate of change.

<Drive of Motor and Valves> FIG. 12 shows a sub process for drive of electric motor M and the valves which is entered from Step S13 of the flow chart of FIG. 4. Control unit 32 is configured to operate as follows.

At Step S500, control unit 32 determines whether or not the mode 0 is currently selected. When the answer to Step S500 is YES, then control unit 32 proceeds to Step S502, at which control unit 32 resets a pump request flag “f_PUMP_REQ” to zero, then proceeds to Step S503, at which control unit 32 sets the inlet gate valves 2P and 2S and outlet gate valves 3P and 3S de-energized, then proceeds to Step S504, at which control unit 32 sets is the inlet solenoid valves 4FL, 4FR, 4RL and 4RR and outlet solenoid valves 5FL, 5FR, 5RL and 5RR de-energized, then proceeds to Step S511, at which control unit 32 applies a soft landing process for preventing the wheel cylinder pressures from rapidly changing or vibrating, and then proceeds to Step S512. On the other hand, when the answer to Step S500 is NO, then control unit 32 proceeds to Step S501.

At Step S501, control unit 32 determines whether or not the mode 1 is currently selected. When the answer to Step S501 is YES, then control unit 32 proceeds to Step S505, at which control unit 32 resets the pump request flag f_PUMP_REQ to zero, then proceeds to Step S506, at which control unit 32 sets the inlet gate valves 2P and 2S and outlet gate valves 3P and 3S de-energized, then proceeds to Step S507, at which control unit 32 controls the openings of the inlet solenoid valves 4FL, 4FR, 4RL and 4RR and outlet solenoid valves 5FL, 5FR, 5RL and 5RR on the basis of the desired wheel cylinder pressures P*(FL), P*(FR), P*(RL) and P*(RR) and the measured wheel cylinder pressures P(FL), P(FR), P(RL) and P(RR), and then proceeds to Step S511. On the other hand, when the answer to Step S501 is NO, that is, when the mode 2 or 3 is currently selected, then control unit 32 proceeds to Step S508.

At Step S508, control unit 32 sets the pump request flag f_PUMP_REQ to 1, then proceeds to Step S509, at which control unit 32 controls the inlet gate valves 2P and 2S and outlet gate valves 3P and 3S on the basis of the desired master cylinder pressure P*_mc and the desired wheel cylinder pressures P*(FL), P*(FR), P*(RL) and P*(RR), then proceeds to Step S510, at which control unit 32 controls the openings of the inlet solenoid valves 4FL, 4FR, 4RL and 4RR and outlet solenoid valves 5FL, 5FR, 5RL and 5RR on the basis of the desired wheel cylinder pressures P*(FL), P*(FR), P*(RL) and P*(RR) and the measured wheel cylinder pressures P(FL), P(FR), P(RL) and P(RR), and then proceeds to Step S511.

At Step S512, control unit 32 determines whether or not the pump request flag f_PUMP_REQ is equal to 1. When the answer to Step S512 is YES, then control unit 32 proceeds to Step S515, at which control unit 32 controls the operation of electric motor M on the basis of the desired wheel cylinder pressures P*(FL), P*(FR), P*(RL) and P*(RR) and the measured wheel cylinder pressures P(FL), P(FR), P(RL) and P(RR), then proceeds to Step S516, at which control unit 32 applies a soft landing process in order to prevent the wheel cylinder pressures from rapidly changing or vibrating, and then returns from this control process to Step S2 in the flow chart of FIG. 4. On the other hand, when the answer to Step S512 is NO, then control unit 32 proceeds to Step S513.

At Step S513, control unit 32 determines whether or not the outlet solenoid valves 5FL, 5FR, 5RL and 5RR are currently opened. When the answer to Step S513 is YES, then control unit 32 proceeds to Step S515, at which control unit 32 controls the operation of electric motor M on the basis of the amount of the brake fluid stored in internal reservoirs 16P and 16S. On the other hand, when the answer to Step S513 is NO, then control is unit 32 proceeds to Step S514, at which control unit 32 sets the electric motor M de-energized, and then proceeds to Step S516.

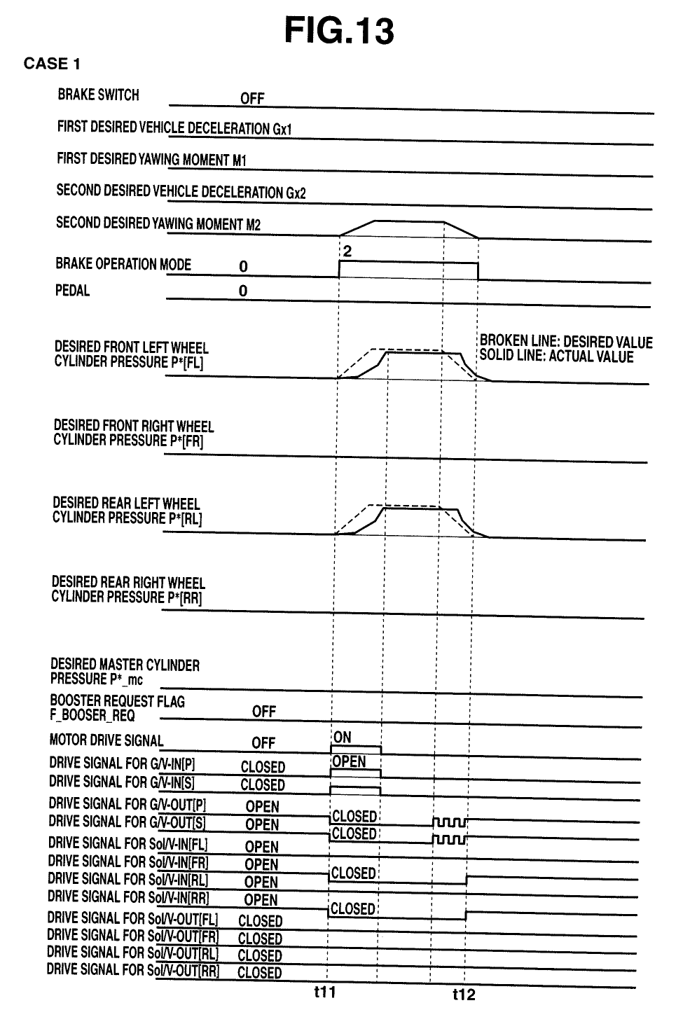

FIG. 13 shows a case of operation of the vehicle behavior control apparatus according to the first embodiment. In this case, the vehicle behavior control apparatus shifts from the mode 0 through the transition C, the mode 2, and the transition D to the mode 0 in the diagram of FIG. 3. In the following, the yawing moment and the yaw rate of the vehicle are defined to be positive in the counterclockwise direction, and negative in the clockwise direction, as viewed from above the vehicle.

At time t11, the second desired yawing moment M2 occurs when in the mode 0. In response, the mode 2 is newly selected in which the drive of electronically-controlled brake booster 1 is disabled and the drive of hydraulic pumps PP and PS is enabled. At the time, the control process proceeds through Steps S100, S101, S102, S103 and S107.

On the basis of the second desired yawing moment M2, the desired wheel cylinder pressures P*(FL), P*(FR), P*(RL) and P*(RR) are computed. In order to attain the second desired yawing moment M2 that is positive and in the counterclockwise direction, the desired front and rear left wheel cylinder pressures P*(FL) and P*(RL) are set suitably, and the desired front and rear right wheel cylinder pressures P*(FR) and P*(RR) are set to zero.

On the other hand, the desired master cylinder pressure P*_mc is set to zero, and the booster request flag f_BOOSER_REQ is reset to zero. At the time, the control process proceeds through Steps S200, S201, S204, S205, S206, S207, S212 and S213.

There is no brake pedal operation by the driver, so that brake switch BS is off. Accordingly, the brake pedal operation mode number PEDAL is set to zero. At the time, the control process proceeds through Steps S300, S304 and S312.

Since the booster request flag f_BOOSER_REQ is equal to zero, the drive current value is set to zero, so that the electronically-controlled brake booster 1 is de-energized. At the time, the control process proceeds through Steps S400, S401 and S403.

Since the drive of hydraulic pumps PP and PS is enabled, electric motor M is driven. The openings of the inlet gate valves 2P and 2S and outlet gate valves 3P and 3S are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR).

Moreover, inlet solenoid valves 4FL and 4RL and outlet solenoid valves 5FL, 5FR, 5RL and 5RR are de-energized, and inlet solenoid valves 4FR and 4RR are closed by energizing, for the front and rear left wheel cylinder pressures P(FL) and P(RL) to be automatically controlled by hydraulic pumps PP and PS. At the time, the control process proceeds through Steps S500, S501, S508, S509, S510, S511, S512, S515 and S516.

At time t12, the second desired yawing moment M2 becomes zero. In response, the mode 0 (mode of normal braking) is selected again. At the time, the control process proceeds through Steps S100, S101, S102, S103, S106, S200, S202, S205, S208, S209, S300, S304, S312, S400, S401, S403, S500, S502, S503, S504, S511, S512, S513, S514 and S516.

In this way, the vehicle behavior control apparatus according to the first embodiment can control the dynamic behavior of the vehicle by producing suitable braking forces at the road wheels by driving the hydraulic pumps PP and PS.

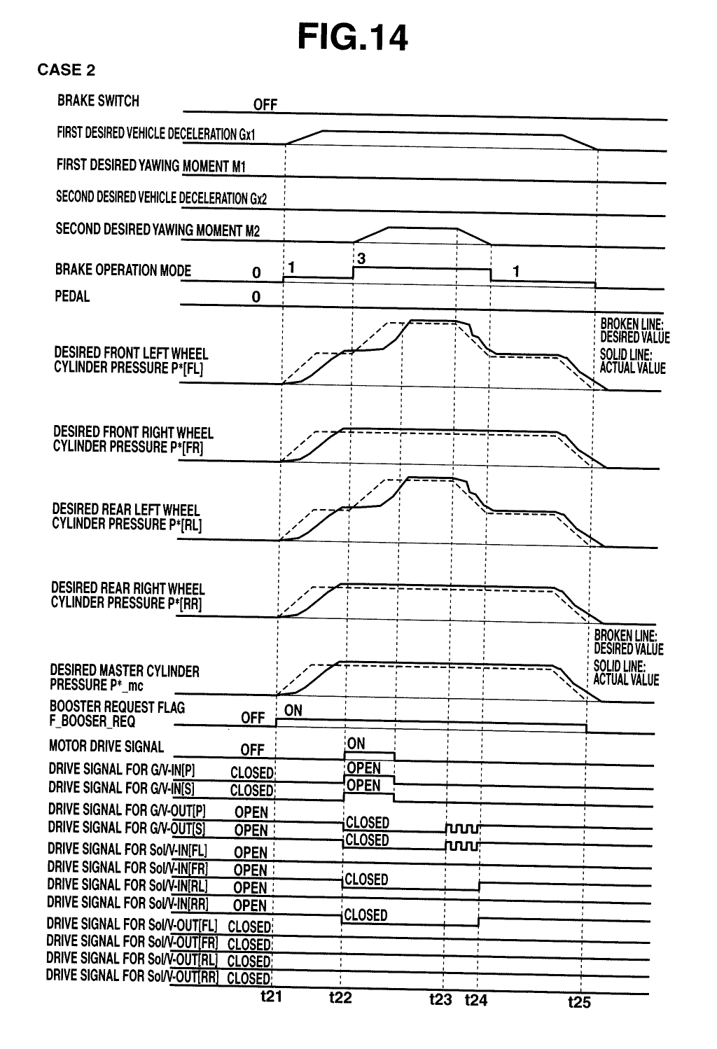

FIG. 14 shows a case of operation of the vehicle behavior control apparatus according to the first embodiment. In this case, the vehicle behavior control apparatus shifts from the mode 0 through the transition A, the mode 1, the transition E, the mode 3, the transition F, the mode 1, and the transition B to the mode 0 in the diagram of FIG. 3.

At time t21, the first desired vehicle deceleration Gx1 occurs when in the mode 0. In response, the mode 1 is newly selected in which the drive of electronically-controlled brake booster 1 is enabled and the drive of hydraulic pumps PP and PS is disabled. At the time, the control process proceeds through Steps S100, S104, S105 and S108.

On the basis of the first desired vehicle deceleration Gx1, the desired wheel cylinder pressures P*(FL), P*(FR), P*(RL) and P*(RR) are computed. Specifically, the desired wheel cylinder pressures P*(FL), P*(FR), P*(RL) and P*(RR) are set to an identical value. The desired master cylinder pressure P*_mc is set to the maximum value of the desired wheel cylinder pressures P*(FL), P*(FR), P*(RL) and P*(RR), i.e. at the identical value, and the booster request flag f_BOOSER_REQ is set to 1. At the time, the control process proceeds through Steps S200, S201, S203, S205, S206, S210 and S211.

There is no brake pedal operation by the driver, so that brake switch BS is off. Accordingly, the brake pedal operation mode number PEDAL is set to zero. At the time, the control process proceeds through Steps S300, S304 and S312.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven. At the time, the control process proceeds through Steps S400, S402 and S403.

Since the drive of hydraulic pumps PP and PS is disabled, electric motor M, inlet gate valves 2P and 2S and outlet gate valves 3P and 3S are de-energized. Moreover, inlet solenoid valves 4FL, 4FR, 4RL and 4RR and outlet solenoid valves 5FL, 5FR, 5RL and 5RR are de-energized, because the desired wheel cylinder pressures P*(FL), P*(FR), P*(RL) and P*(RR) are identical to each other. At the time, the control process proceeds through Steps S500, S501, S505, S506, S507, S511, S512, S513, S514 and S516.

At time t22, the second desired yawing moment M2 occurs when in the mode 1. In response, the mode 3 is newly selected in which the drive of electronically-controlled brake booster 1 is enabled and the drive of hydraulic pumps PP and PS is enabled. At the time, the control process proceeds through Steps S100, S104, S105 and S109.

On the basis of the first desired vehicle deceleration Gx1 and the second desired yawing moment M2, the desired wheel cylinder pressures P*(FL), P*(FR), P*(RL) and P*(RR) are computed. The desired master cylinder pressure P*_mc is set to the last value, and the booster request flag f_BOOSER_REQ is set to 1. At the time, the control process proceeds through Steps S200, S201, S204, S205, S206, S207, S214 and S215.

There is no brake pedal operation by the driver, so that brake switch BS is off. Accordingly, the brake pedal operation mode number PEDAL is set to zero.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is enabled, electric motor M is driven. The openings of the inlet gate valves 2P and 2S and outlet gate valves 3P and 3S are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR). Moreover, inlet solenoid valves 4FL and 4RL and outlet solenoid valves 5FL and 5RL are de-energized, and the openings of inlet solenoid valves 4FR and 4RR and outlet solenoid valves 5FR and 5RR are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR).

At time t24, the second desired yawing moment M2 becomes zero. In response, the mode 1 is selected again in which the drive of electronically-controlled brake booster 1 is enabled and the drive of hydraulic pumps PP and PS is disabled. The control method from time t24 to time t25 is the same as that from time t21 to time t22.

At time t25, the first desired vehicle deceleration Gx1 becomes zero. In response, the mode 0 (mode of normal braking) is selected again.

In this way, the vehicle behavior control apparatus according to the first embodiment can control the dynamic behavior of the vehicle by producing suitable braking forces at the road wheels by shifting from the mode 1 (in which the drive of electronically-controlled brake booster 1 is enabled and the drive of hydraulic pumps PP and PS is disabled) to the mode 3 (in which the drive of electronically-controlled brake booster 1 is enabled and the drive of hydraulic pumps PP and PS is enabled), and shifting back from the mode 3 to the mode 1.

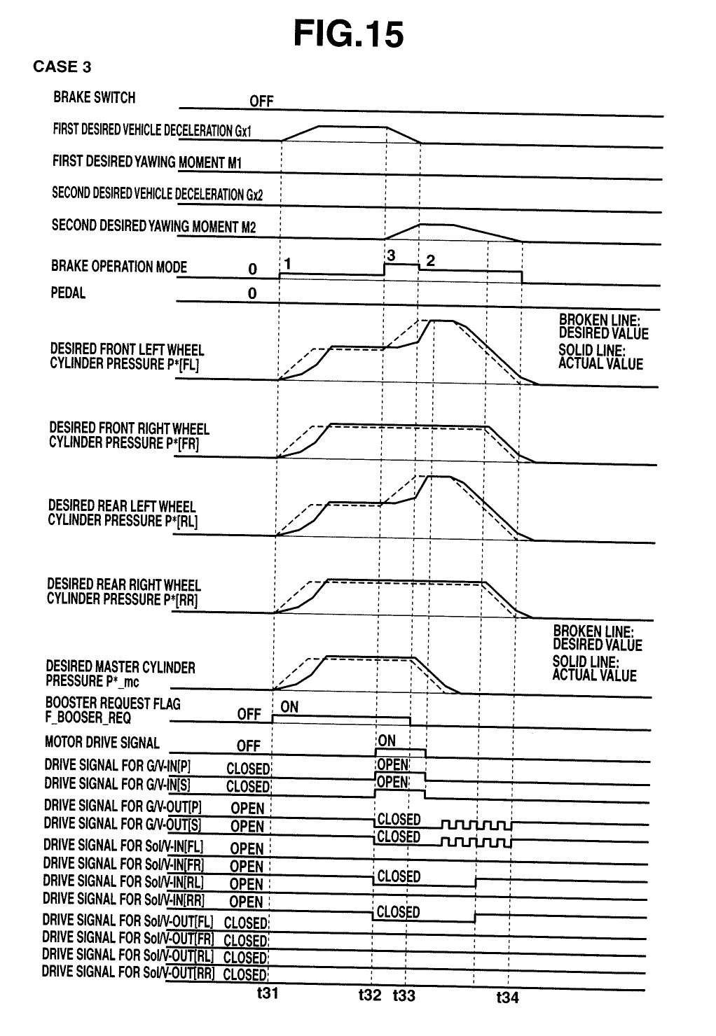

FIG. 15 shows a case of operation of the vehicle behavior control apparatus according to the first embodiment. In this case, the vehicle behavior control apparatus shifts from the mode 0 through the transition A, the mode 1, the transition E, the mode 3, the transition G, the mode 2, and the transition D to the mode 0 in the diagram of FIG. 3.

At time t33, the first desired vehicle deceleration Gx1 becomes zero. In response, the mode 2 is selected in which the drive of electronically-controlled brake booster 1 is disabled and the drive of hydraulic pumps PP and PS is enabled.

On the basis of the second desired yawing moment M2, the desired wheel cylinder pressures P*(FL), P*(FR), P*(RL) and P*(RR) are computed. In order to attain the second desired yawing moment M2 that is positive and in the counterclockwise direction, the desired front and rear left wheel cylinder pressures P*(FL) and P*(RL) are increased, and the desired front and rear right wheel cylinder pressures P*(FR) and P*(RR) are unchanged. Moreover, the desired master cylinder pressure P*_mc is set to zero, and the booster request flag f_BOOSER_REQ is reset to zero.

There is no brake pedal operation by the driver, so that brake switch BS is off. Accordingly, the brake pedal operation mode number PEDAL is set to zero. Since the booster request flag f_BOOSER_REQ is equal to zero, the drive current value is set to zero, so that the electronically-controlled brake booster 1 is de-energized.

Since the drive of hydraulic pumps PP and PS is enabled, electric motor M is driven. The openings of the inlet gate valves 2P and 2S and outlet gate valves 3P and 3S are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR). Moreover, inlet solenoid valves 4FL and 4RL and outlet solenoid valves 5FL, 5FR, 5RL and 5RR are de-energized, and inlet solenoid valves 4FR and 4RR are closed by energizing, for the front and rear left wheel cylinder pressures P(FL) and P(RL) to be automatically controlled by hydraulic pumps PP and PS.

Thereafter, the control method is the same as that after time t11 in the case of FIG. 13.

In this way, the vehicle behavior control apparatus according to the first embodiment can control the dynamic behavior of the vehicle by producing suitable braking forces at the road wheels by shifting from the mode 1 (in which the drive of electronically-controlled brake booster 1 is enabled and the drive of hydraulic pumps PP and PS is disabled) to the mode 3 (in which the drive of electronically-controlled brake booster 1 is enabled and the drive of hydraulic pumps PP and PS is enabled), and shifting from the mode 3 to the mode 2 (in which the drive of electronically-controlled brake booster 1 is disabled and the drive of hydraulic pumps PP and PS is enabled).

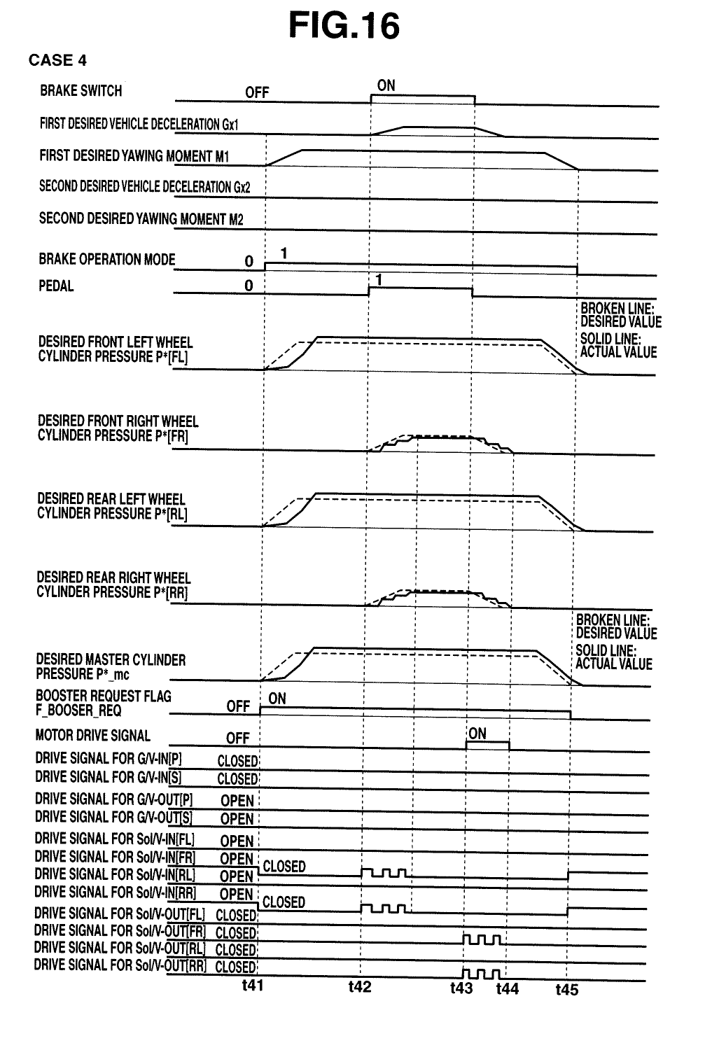

FIG. 16 shows a case of operation of the vehicle behavior control apparatus according to the first embodiment. In this case, the vehicle behavior control apparatus shifts from the mode 0 through the transition A to the mode 1 in the diagram of FIG. 3, and then brake pedal BP is depressed by the driver.

At time t41, the first desired yawing moment M1 occurs when in the mode 0. In response, the mode 1 is newly selected in which the drive of electronically-controlled brake booster 1 is enabled and the drive of hydraulic pumps PP and PS is disabled.

On the basis of the first desired yawing moment M1, the desired wheel cylinder pressures P*(FL), P*(FR), P*(RL) and P*(RR) are computed. In order to attain the first desired yawing moment M1 that is positive and in the counterclockwise direction, the desired front and rear left wheel cylinder pressures P*(FL) and P*(RL) are set suitably, and the desired front and rear right wheel cylinder pressures P*(FR) and P*(RR) are set to zero. Moreover, the desired master cylinder pressure P*_mc is set to the maximum value of the desired wheel cylinder pressures P*(FL), P*(FR), P*(RL) and P*(RR), and the booster request flag f_BOOSER_REQ is set to 1.

There is no brake pedal operation by the driver, so that brake switch BS is off. Accordingly, the brake pedal operation mode number PEDAL is set to zero.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL and 4RL and outlet solenoid valves 5FL, 5FR, 5RL and 5RR are de-energized, and inlet solenoid valves 4FR and 4RR are closed by energizing, for the front and rear left wheel cylinder pressures P(FL) and P(RL) to be automatically controlled by electronically-controlled brake booster 1.

At time t42, the driver operates the brake pedal BP. In response, brake switch BS is turned on. Simultaneously, the first desired vehicle deceleration Gx1 occurs. In response, the mode 1 continues to be selected in which the drive of electronically-controlled brake booster 1 is enabled and the drive of hydraulic pumps PP and PS is disabled.

On the basis of the first desired vehicle deceleration Gx1 and the first desired yawing moment M1, the desired wheel cylinder pressures P*(FL), P*(FR), P*(RL) and P*(RR) are computed. The desired front and rear right wheel cylinder pressures P*(FR) and P*(RR) are suitably increased from zero, in order to attain the first desired vehicle deceleration Gx1. The desired master cylinder pressure P*_mc is set to the maximum value of the desired wheel cylinder pressures P*(FL), P*(FR), P*(RL) and P*(RR), and the booster request flag f_BOOSER_REQ is set to 1.

At the time, brake switch BS is on, but, when the amount of brake pedal operation is below the controlled hydraulic pressure of electronically-controlled brake booster 1, then the brake pedal operation mode number PEDAL is set to 1. At the time, the control process proceeds through Steps S300, S301, S302, S303, S307 and S316.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL and 4RL and outlet solenoid valves 5FL and 5RL are de-energized, and the openings of inlet solenoid valves 4FR and 4RR and outlet solenoid valves 5FR and 5RR are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR).

At time t43, the driver releases the brake pedal BP. In response, brake switch BS is turned off. Simultaneously, the first desired vehicle deceleration Gx1 decreases. In response, the mode 1 continues to be selected in which the drive of electronically-controlled brake booster 1 is enabled and the drive of hydraulic pumps PP and PS is disabled.

On the basis of the first desired yawing moment M1, the desired wheel cylinder pressures P*(FL), P*(FR), P*(RL) and P*(RR) are computed. The desired master cylinder pressure P*_mc is set to the maximum value of the desired wheel cylinder pressures P*(FL), P*(FR), P*(RL) and P*(RR), and the booster request flag f_BOOSER_REQ is set to 1.

At the time, brake switch BS is off, and then the brake pedal operation mode number PEDAL is set to 0.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, inlet gate valves 2P and 2S and outlet gate valves 3P and 3S are de-energized. Moreover, inlet solenoid valves 4FL and 4RL and outlet solenoid valves 5FL and 5RL are de-energized, and the openings of inlet solenoid valves 4FR and 4RR and outlet solenoid valves 5FR and 5RR are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR).

Since outlet solenoid valves 5FR and 5RR are opened, electric motor M is driven in order to return the brake fluid in internal reservoirs 16P and 16S to master cylinder M/C. At the time, the control process proceeds through Steps S500, S501, S505, S506, S507, S511, S512, S513, S515 and S516.

Thereafter, the control method is the same as that from time t11 to time t21 in the case of FIG. 13.

In this way, when the driver operates the brake pedal under condition that the yawing moment is generated by the vehicle behavior control in the mode 1 (in which the drive of electronically-controlled brake booster 1 is enabled and the drive of hydraulic pumps PP and PS is disabled), then the vehicle behavior control apparatus according to the first embodiment can control the dynamic behavior of the vehicle by producing suitable braking forces at the road wheels that have been subject to no braking forces before the brake pedal operation. That is, the vehicle behavior control apparatus according to the first embodiment controls internal pressures of the second and fourth wheel cylinders by adjusting openings of the second and fourth pressure-increasing valves in accordance with the operation of the brake pedal, in response to determining that the operation of the brake pedal is present under condition that the first and third wheel cylinders are pressurized by operating the first hydraulic system, opening the first and third pressure-increasing valves, and closing the second and fourth pressure-increasing valves. Then, the vehicle behavior control apparatus depressurizes the second and fourth wheel cylinders by adjusting openings of the second and fourth pressure-reducing valves, in response to determining that the operation of the brake pedal is reduced under condition that internal pressures of the first, second, third and fourth wheel cylinders are controlled by operating the first hydraulic system, opening the first and third pressure-increasing valves, and adjusting openings of the second and fourth pressure-increasing valves in accordance with the operation of the brake pedal. Thus, even when the vehicle behavior control is active, the driver's brake pedal operation can be satisfied.

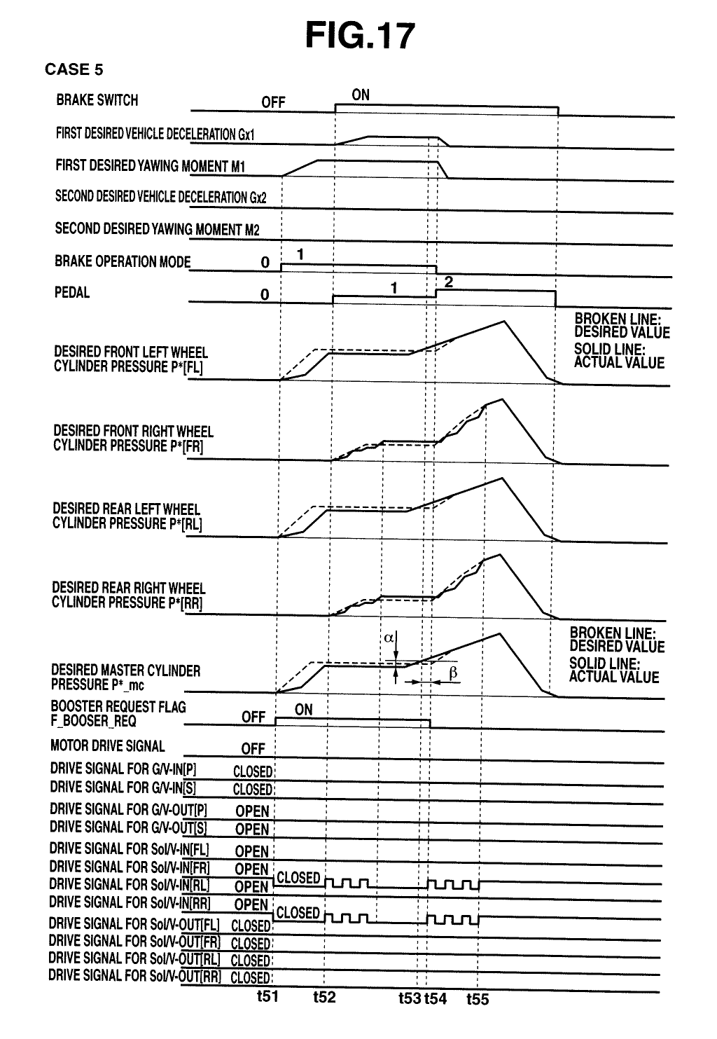

FIG. 17 shows a case of operation of the vehicle behavior control apparatus according to the first embodiment. In this case, the vehicle behavior control apparatus shifts from the mode 0 through the transition A to the mode 1 in the diagram of FIG. 3, and then brake pedal BP is depressed by the driver. Until time t53, the control method is the same as that from time t41 to time t43 in the case of FIG. 16.

At time t53, the driver increases the depression of brake pedal BP. In response, the difference between the desired master cylinder pressure P*_mc and the master cylinder pressure P_mc exceeds the predetermined reference value α. During the brake pedal identification at Step S11 of the flow chart of FIG. 4, the counter value COUNT starts to be incremented. At the time, the control process proceeds through Steps S300, S301, S302, S303, S308, S311 and S317.

When the predetermined reference period of time P has elapsed after time t53 under condition that the difference between the desired master cylinder pressure P*_mc and the master cylinder pressure P_mc is larger than the predetermined reference value α, then it is identified that the driver has increased the depression of brake pedal BP, and then the brake pedal operation mode number PEDAL is set to 2. At the time, the control process proceeds through Steps S300, S301, S302, S303, S308, S311 and S318.

At time t54, the first desired vehicle deceleration Gx1 and the first desired yawing moment M1 decrease to zero. In response, the mode 0 is selected again. The soft landing process is applied to operations of the electronically-controlled brake booster 1 and the valves at Steps 403 and S511, respectively. After a delay, the shift to the mode 0 (for normal braking) is completed at time t55.

In this way, when the driver increases the depression of the brake pedal under condition that the yawing moment is generated by the vehicle behavior control in the mode 1 (in which the drive of electronically-controlled brake booster 1 is enabled and the drive of hydraulic pumps PP and PS is disabled), then the vehicle behavior control apparatus according to the first embodiment can control the dynamic behavior of the vehicle by setting the wheel cylinder pressures equal to the master cylinder pressure, and then shifts to the mode 0. That is, the vehicle behavior control apparatus according to the first embodiment conforms internal pressures of the first, second, third and fourth wheel cylinders to an internal pressure of the master cylinder by adjusting openings of the second and fourth pressure-increasing valves, in response to determining that the operation of the brake pedal is increased under condition that the internal pressures of the first, second, third and fourth wheel cylinders are controlled by operating the first hydraulic system, opening the first and third pressure-increasing valves, and adjusting the openings of the second and fourth pressure-increasing valves in accordance with the operation of the brake pedal. Thus, when the driver's brake pedal operation is above the controlled hydraulic pressure, the vehicle behavior control apparatus prioritizes the driver's brake pedal operation, so as for the driver not is to feel uncomfortable.

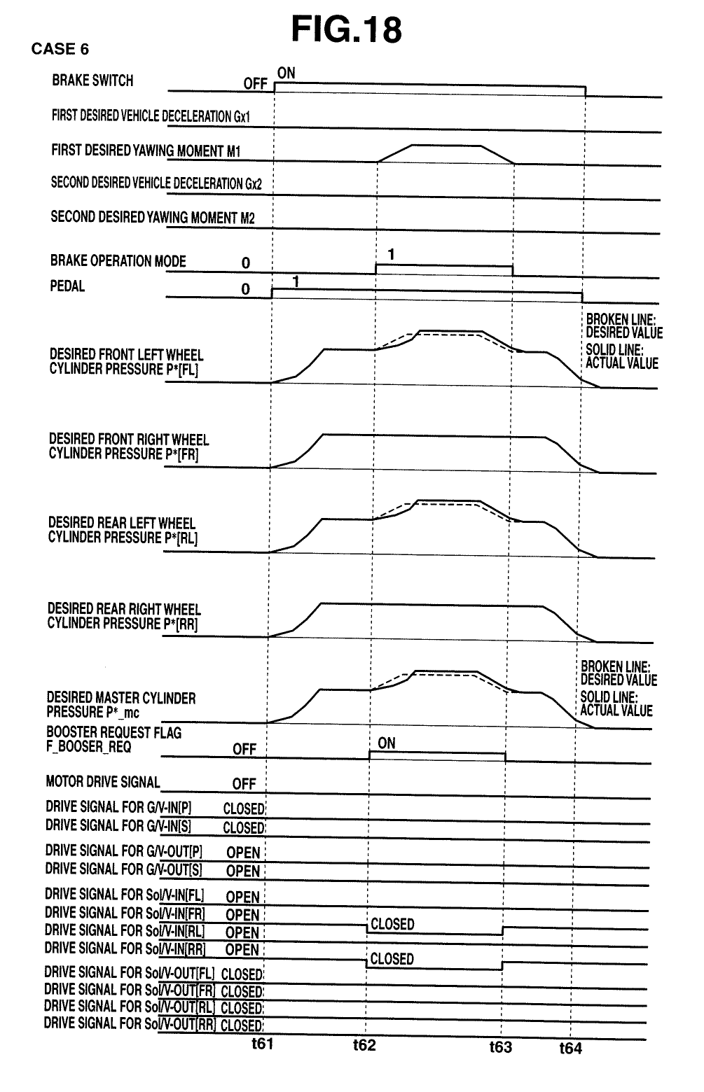

FIG. 18 shows a case of operation of the vehicle behavior control apparatus according to the first embodiment. In this case, under condition that the brake pedal BP is depressed by the driver, the vehicle behavior control apparatus shifts from the mode 0 through the transition A, the mode 1 and the transition B to the mode 0 in the diagram of FIG. 3.

At time t61, the driver operates brake pedal BP. In response, the wheel cylinder pressures P(FL), P(FR), P(RL) and P(RR) increase according to the depression of brake pedal BP.

At time t62, the first desired yawing moment M1 occurs in the mode 0. In response, the mode 1 is newly selected in which the drive of electronically-controlled brake booster 1 is enabled and the drive of hydraulic pumps PP and PS is disabled.

On the basis of the first desired yawing moment M1, the desired wheel cylinder pressures P*(FL), P*(FR), P*(RL) and P*(RR) are computed. In order to attain the first desired yawing moment M1 that is positive and in the counterclockwise direction, the desired front and rear left wheel cylinder pressures P*(FL) and P*(RL) are increased suitably, and the desired front and rear right wheel cylinder pressures P*(FR) and P*(RR) are unchanged. Moreover, the desired master cylinder pressure P*_mc is set to the maximum value of the desired wheel cylinder pressures P*(FL), P*(FR), P*(RL) and P*(RR), and the booster request flag f_BOOSER_REQ is set to 1.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL and 4RL and outlet solenoid valves 5FL, 5FR, 5RL and 5RR are de-energized, and inlet solenoid valves 4FR and 4RR are closed by energizing, for the front and rear left wheel cylinder pressures P(FL) and P(RL) to be automatically controlled by electronically-controlled brake booster 1.

At time t63, the first desired yawing moment M1 becomes zero. In response, the mode 0 is selected again.

In this way, the vehicle behavior control apparatus according to the first embodiment identifies the operation of the brake pedal, and pressurizes the first and third wheel cylinders, and holds constant internal pressures of the second and fourth wheel cylinders, by operating the first hydraulic system (electronically-controlled brake booster 1), opening the first and third pressure-increasing valves, and closing the second and fourth pressure-increasing valves, in response to determining that a request concerning a yaw movement of the vehicle and constituting the first operation request is present under condition that the operation of the brake pedal is present. This allows the yawing moment to develop smoothly.

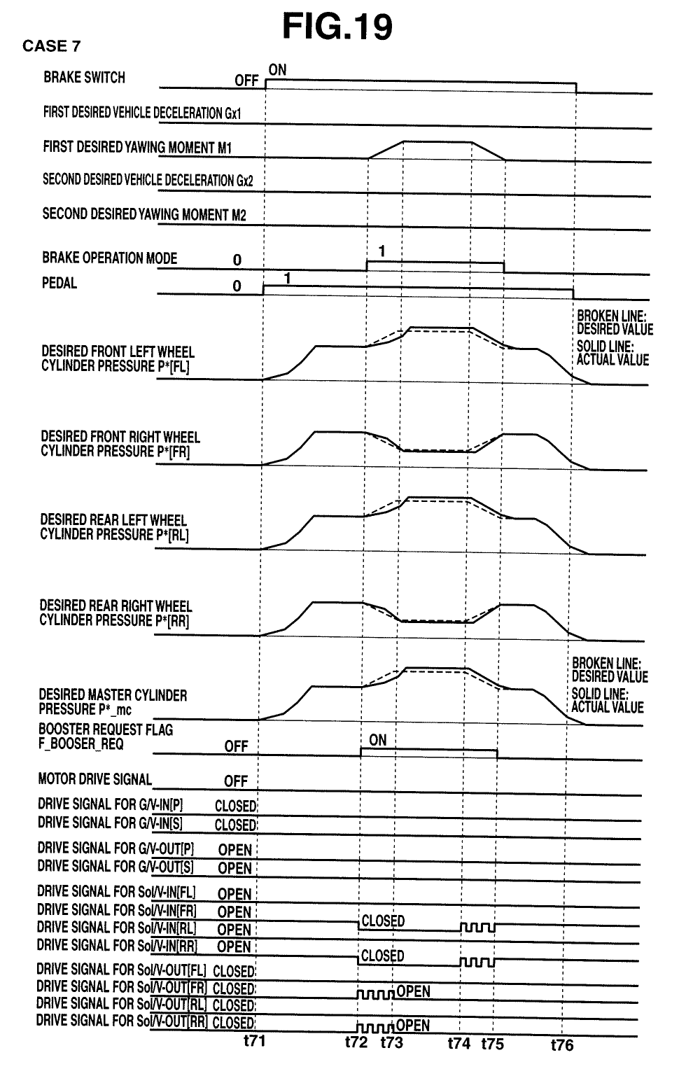

FIG. 19 shows a case of operation of the vehicle behavior control apparatus according to the first embodiment. In this case, under condition that the brake pedal BP is depressed by the driver, the vehicle behavior control apparatus shifts from the mode 0 through the transition A, the mode 1 and the transition B to the mode 0 in the diagram of FIG. 3.

At time t71, the driver operates brake pedal BP. In response, the wheel cylinder pressures P(FL), P(FR), P(RL) and P(RR) increase according to the depression of brake pedal BP.

At time t72, the first desired yawing moment M1 occurs in the mode 0. In response, the mode 1 is newly selected in which the drive of electronically-controlled brake booster 1 is enabled and the drive of hydraulic pumps PP and PS is disabled.

On the basis of the first desired yawing moment M1, the desired wheel cylinder pressures P*(FL), P*(FR), P*(RL) and P*(RR) are computed. In order to attain the first desired yawing moment M1 that is positive and in the counterclockwise direction, the desired front and rear left wheel cylinder pressures P*(FL) and P*(RL) are increased suitably, and the desired front and rear right wheel cylinder pressures P*(FR) and P*(RR) are reduced suitably. Moreover, the desired master cylinder pressure P*_mc is set to the maximum value of the desired wheel cylinder pressures P*(FL), P*(FR), P*(RL) and P*(RR), and the booster request flag f_BOOSER_REQ is set to 1.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL and 4RL and outlet solenoid valves 5FL and 5RL are de-energized, inlet solenoid valves 4FR and 4RR are closed by energizing, and the openings of outlet solenoid valves 5FR and 5RR are suitably controlled by opening and closing. As a result, the front and rear left wheel cylinder pressures P(FL) and P(RL) increase, and the front and rear right wheel cylinder pressures P(FR) and P(RR) decease.

Until time t74 after time t73, the first desired yawing moment M1 is constant. In response, the inlet solenoid valves 4FL and 4RL and outlet solenoid valves 5FL and 5RL are held de-energized, and inlet solenoid valves 4FR and 4RR and outlet solenoid valves 5FR and 5RR are closed. The wheel cylinder pressures are thus held constant.

Until time t75 after time t74, the first desired yawing moment M1 decreases to zero. In response, inlet solenoid valves 4FL and 4RL and outlet solenoid valves 5FL and 5RL are held de-energized, the openings of inlet solenoid valves 4FR and 4RR are controlled by opening and closing, and outlet solenoid valves 5FR and 5RR are closed. As a result, the front and rear left wheel cylinder pressures P(FL) and P(RL) decrease, and the front and rear right wheel cylinder pressures P(FR) and P(RR) increase.

At time t75, the first desired yawing moment M1 becomes zero. In response, the mode 0 is selected again.

In this way, the vehicle behavior control apparatus according to the first embodiment identifies the operation of the brake pedal, and pressurizes the first and third wheel cylinders, and depressurizes the second and fourth wheel cylinders, by operating the first hydraulic system (electronically-controlled brake booster 1), opening the first and third pressure-increasing valves, closing the second and fourth pressure-increasing valves, and adjusting openings of the second and fourth pressure-reducing valves, in response to determining that a request concerning a yaw movement of the vehicle and constituting the first operation request is present under condition that the operation of the brake pedal is present. This allows the yawing moment to increase for control of the dynamic behavior of the vehicle under condition that the total braking force is held constant according to the operation of the brake pedal.

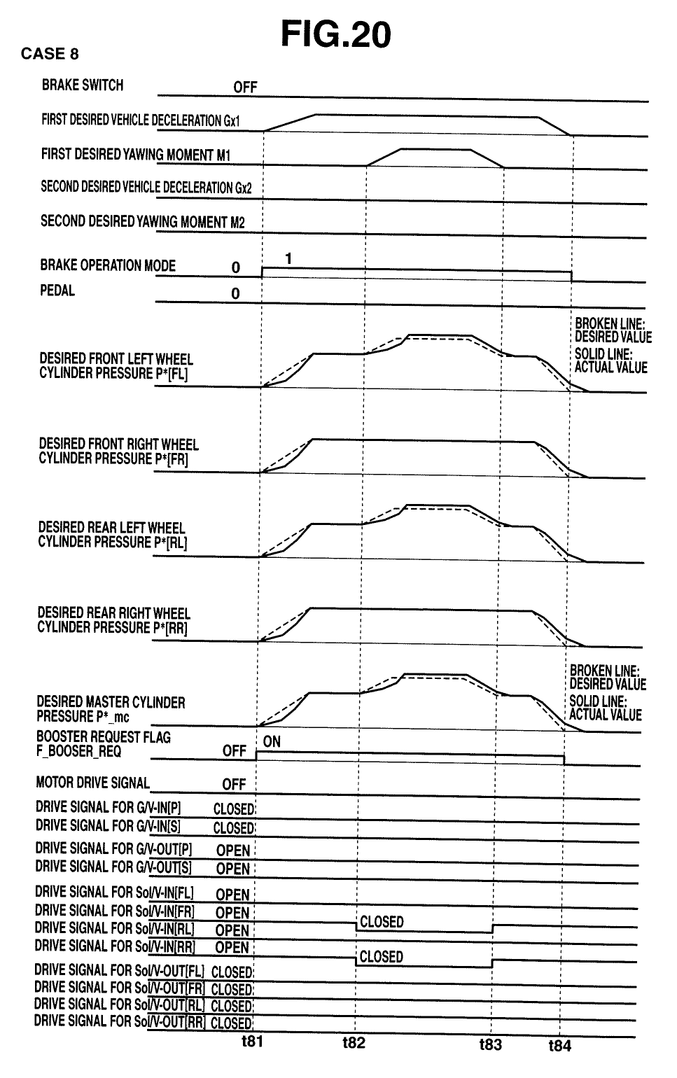

FIG. 20 shows a case of operation of the vehicle behavior control apparatus according to the first embodiment. In this case, the vehicle behavior control apparatus shifts from the mode 0 through the transition A, the mode 1 and the transition B to the mode 0 in the diagram of FIG. 3.

At time t81, the first desired vehicle deceleration is Gx1 occurs when in the mode 0. In response, the mode 1 is newly selected in which the drive of electronically-controlled brake booster 1 is enabled and the drive of hydraulic pumps PP and PS is disabled.

On the basis of the first desired vehicle deceleration Gx1, the desired wheel cylinder pressures P*(FL), P*(FR), P*(RL) and P*(RR) are computed. Specifically, the desired wheel cylinder pressures P*(FL), P*(FR), P*(RL) and P*(RR) are set to an identical value. The desired master cylinder pressure P*_mc is set to the maximum value of the desired wheel cylinder pressures P*(FL), P*(FR), P*(RL) and P*(RR), i.e. at the identical value, and the booster request flag f_BOOSER_REQ is set to 1.

There is no brake pedal operation by the driver, so that brake switch BS is off. Accordingly, the brake pedal operation mode number PEDAL is set to zero.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL, 4FR, 4RL and 4RR and outlet solenoid valves 5FL, 5FR, 5RL and 5RR are de-energized, because the desired wheel cylinder pressures P*(FL), P*(FR), P*(RL) and P*(RR) are identical to each other.

At time t82, the first desired yawing moment M1 occurs when in the mode 1. In response, the mode 1 continues to be selected in which the drive of electronically-controlled brake booster 1 is enabled and the drive of hydraulic pumps PP and PS is disabled.

On the basis of the first desired vehicle deceleration Gx1 and the first desired yawing moment M1, the desired wheel cylinder pressures P*(FL), P*(FR), P*(RL) and P*(RR) are computed. In order to attain the first desired yawing moment M1 that is positive and in the counterclockwise direction, the desired front and rear left wheel cylinder pressures P*(FL) and P*(RL) are increased suitably, and the desired front and rear right wheel cylinder pressures P*(FR) and P*(RR) are unchanged. Moreover, the desired master cylinder pressure P*-mc is set to the maximum value of the desired wheel cylinder pressures P*(FL), P*(FR), P*(RL) and P*(RR), and the booster request flag f_BOOSER_REQ is set to 1.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL and 4RL and outlet solenoid valves 5FL, 5FR, 5RL and 5RR are de-energized, and inlet solenoid valves 4FR and 4RR are closed by energizing, for the front and rear left wheel cylinder pressures P(FL) and P(RL) to be automatically controlled by electronically-controlled brake booster 1.

At time t83, the first desired yawing moment M1 becomes zero. In response, the mode 1 continues to be selected in which the drive of electronically-controlled brake booster 1 is enabled and the drive of hydraulic pumps PP and PS is disabled. The control method from time t83 to time t84 is the same as that from time t81 to time t82.

At time t84, the first desired vehicle deceleration Gx1 becomes zero. In response, the mode 0 is selected again.

In this way, the vehicle behavior control apparatus according to the first embodiment pressurizes the first and third wheel cylinders, and holds constant internal pressures of the second and fourth wheel cylinders, by opening the first and third pressure-increasing valves, and closing the second and fourth pressure-increasing valves, in response to determining that a request concerning a yaw movement of the vehicle and constituting the first operation request turns present under condition that the first hydraulic system is activated in response to a request concerning a longitudinal movement of the vehicle and constituting the first operation request. This allows the yawing moment to develop smoothly.

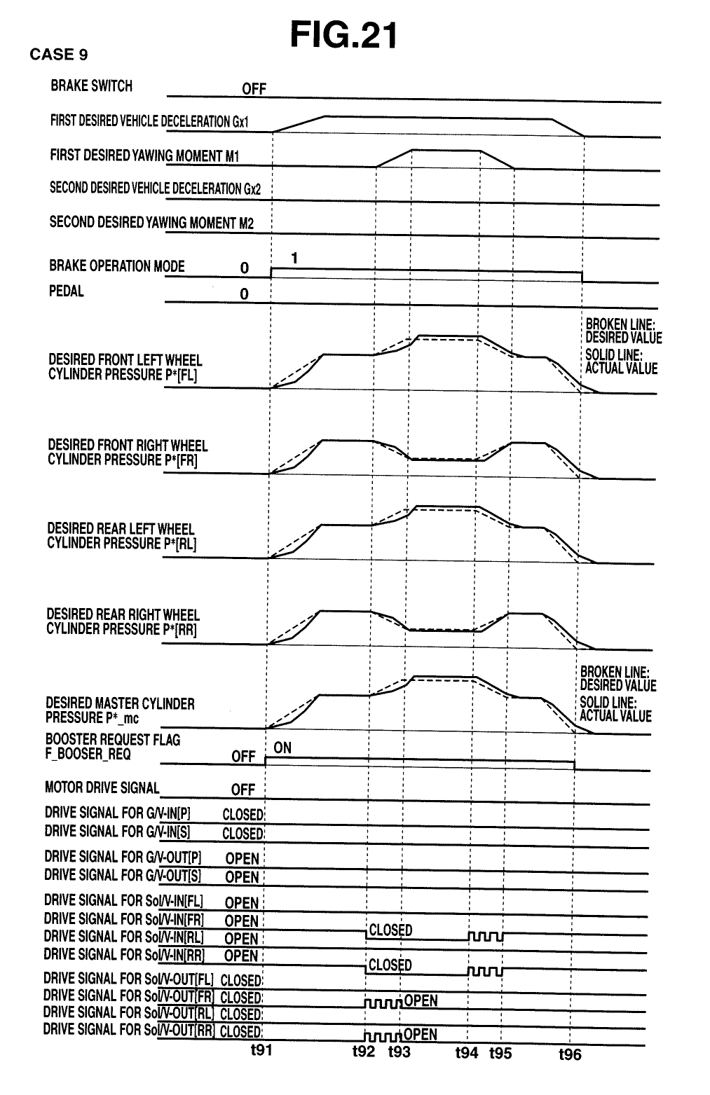

FIG. 21 shows a case of operation of the vehicle behavior control apparatus according to the first embodiment. In this case, the vehicle behavior control apparatus shifts from the mode 0 through the transition A, the mode 1 and the transition B to the mode 0 in the diagram of FIG. 3.

At time t91, the first desired vehicle deceleration Gx1 occurs when in the mode 0. In response, the mode 1 is newly selected in which the drive of electronically-controlled brake booster 1 is enabled and the drive of hydraulic pumps PP and PS is disabled.

On the basis of the first desired vehicle deceleration Gx1, the desired wheel cylinder pressures P*(FL), P*(FR), P*(RL) and P*(RR) are computed. Specifically, the desired wheel cylinder pressures P*(FL), P*(FR), P*(RL) and P*(RR) are set to an identical value. The desired master cylinder pressure P*_mc is set to the maximum value of the desired wheel cylinder pressures P*(FL), P*(FR), P*(RL) and P*(RR), i.e. at the identical value, and the booster request flag f_BOOSER_REQ is set to 1.

There is no brake pedal operation by the driver, so that brake switch BS is off. Accordingly, the brake pedal operation mode number PEDAL is set to zero.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL, 4FR, 4RL and 4RR and outlet solenoid valves 5FL, 5FR, 5RL and 5RR are de-energized, because the desired wheel cylinder pressures P*(FL), P*(FR), P*(RL) and P*(RR) are identical to each other.

At time t92, the first desired yawing moment M1 occurs when in the mode 1. In response, the mode 1 continues to be selected in which the drive of electronically-controlled brake booster 1 is enabled and the drive of hydraulic pumps PP and PS is disabled.

On the basis of the first desired vehicle deceleration Gx1 and the first desired yawing moment M1, the desired wheel cylinder pressures P*(FL), P*(FR), P*(RL) and P*(RR) are computed. In order to attain the first desired yawing moment M1 that is positive and in the counterclockwise direction, the desired front and rear left wheel cylinder pressures P*(FL) and P*(RL) are increased suitably, and the desired front and rear right wheel cylinder pressures P*(FR) and P*(RR) are reduced suitably. Moreover, the desired master cylinder pressure P*_mc is set to the maximum value of the desired wheel cylinder pressures P*(FL), P*(FR), P*(RL) and P*(RR), and the booster request flag f_BOOSER_REQ is set to 1.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL and 4RL and outlet solenoid valves 5FL and 5RL are de-energized for the front and rear left wheel cylinder pressures P(FL) and P(RL) to be automatically controlled by electronically-controlled brake booster 1, and inlet solenoid valves 4FR and 4RR are closed by energizing and the openings of outlet solenoid valves 5FR and 5RR are controlled by opening and closing.

Until time t94 after time t93, the first desired yawing moment M1 is constant. In response, inlet solenoid valves 4FL and 4RL and outlet solenoid valves 5FL, 5FR, 5RL and 5RR are held de-energized, and inlet solenoid valves 4FR and 4RR are held closed by energizing. The wheel cylinder pressures P(FL), P(FR), P(RL) and P(RR) are thus maintained.

Until time t95 after time t94, the first desired yawing moment M1 decreases to zero. In response, inlet solenoid valves 4FL and 4RL and outlet solenoid valves 5FL, 5FR, 5RL and 5RR are held de-energized, and the openings of inlet solenoid valves 4FR and 4RR are controlled by opening and closing. The front and rear left wheel cylinder pressures P(FL) and P(RL) are thus reduced, whereas the measured front and rear right wheel cylinder pressures P(FR) and P(RR) are thus increased.

At time t95, the first desired yawing moment M1 becomes zero. In response, the mode 1 continues to be selected in which the drive of electronically-controlled brake booster 1 is enabled and the drive of hydraulic pumps PP and PS is disabled. The control method from time t95 to time t96 is the same as that from time t91 to time t92.

At time t96, the first desired vehicle deceleration Gx1 becomes zero. In response, the mode 0 is selected again.

In this way, the vehicle behavior control apparatus according to the first embodiment pressurizes the first and third wheel cylinders, and depressurizes the second and fourth wheel cylinders, by opening the first and third pressure-increasing valves, closing the second and fourth pressure-increasing valves, and adjusting openings of the second and fourth pressure-reducing valves, in response to determining that a request concerning a yaw movement of the vehicle and constituting the first operation request turns present under condition that the first hydraulic system is activated in response to a request concerning a longitudinal movement of the vehicle and constituting the first operation request. This allows the yawing moment to increase for control of the dynamic behavior of the vehicle under condition that the total braking force is held constant.

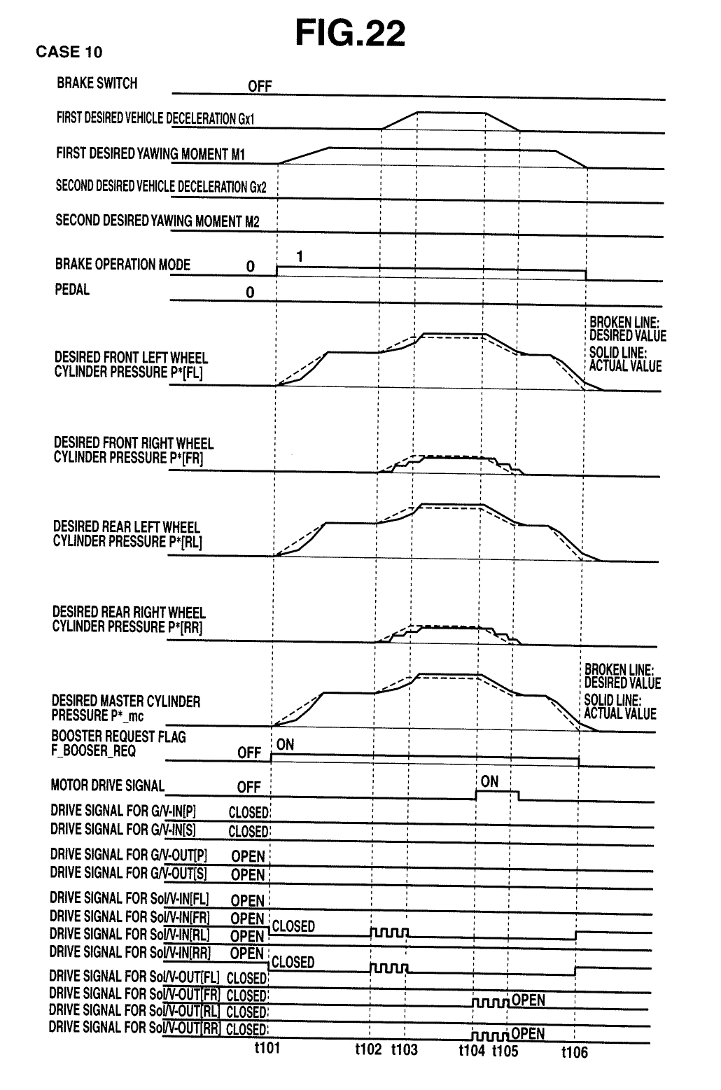

FIG. 22 shows a case of operation of the vehicle behavior control apparatus according to the first embodiment. In this case, the vehicle behavior control apparatus shifts from the mode 0 through the transition A, the mode 1 and the transition B to the mode 0 in the diagram of FIG. 3.

At time t101, the first desired yawing moment M1 occurs when in the mode 0. In response, the mode 1 is newly selected in which the drive of electronically-controlled brake booster 1 is enabled and the drive of hydraulic pumps PP and PS is disabled.

On the basis of the first desired yawing moment M1, the desired wheel cylinder pressures P*(FL), P*(FR), P*(RL) and P*(RR) are computed. In order to attain the first desired yawing moment M1 that is positive and in the counterclockwise direction, the desired front and rear left wheel cylinder pressures P*(FL) and P*(RL) are set suitably, and the desired front and rear right wheel cylinder pressures P*(FR) and P*(RR) are set to zero. Moreover, the desired master cylinder pressure P*_mc is set to the maximum value of the desired wheel cylinder pressures P*(FL), P*(FR), P*(RL) and P*(RR), and the booster request flag f_BOOSER_REQ is set to 1.

There is no brake pedal operation by the driver, so that brake switch BS is off. Accordingly, the brake pedal operation mode number PEDAL is set to zero.

Since the booster request flag f_BOOSER_PREQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL and 4RL and outlet solenoid valves 5FL, 5FR, 5RL and 5RR are de-energized, and inlet solenoid valves 4FR and 4RR are closed by energizing, for the front and rear left wheel cylinder pressures P(FL) and P(RL) to be automatically controlled by electronically-controlled brake booster 1.

At time t102, the first desired vehicle deceleration Gx1 occurs when in the mode 1. In response, the mode 1 continues to be selected in which the drive of electronically-controlled brake booster 1 is enabled and the drive of hydraulic pumps PP and PS is disabled.

On the basis of the first desired vehicle deceleration Gx1 and the first desired yawing moment M1, the desired wheel cylinder pressures P*(FL), P*(FR), P*(RL) and P*(RR) are computed. In order to further attain the first desired vehicle deceleration Gx1, all of the desired wheel cylinder pressures P*(FL), P*(FR), P*(RL) and P*(RR) are increased suitably, where the desired front and rear right wheel cylinder pressures P*(FR) and P*(RR) are increased from zero. Moreover, the desired master cylinder pressure P*_mc is set to the maximum value of the desired wheel cylinder pressures P*(FL), P*(FR), P*(RL) and P*(RR), and the booster request flag f_BOOSER_REQ is set to 1.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, inlet gate valves 2P and 2S and outlet gate valves 3P and 3S are de-energized. Moreover, inlet solenoid valves 4FL and 4RL and outlet solenoid valves 5FL and 5RL are de-energized for the front and rear left wheel cylinder pressures P(FL) and P(RL) to be automatically controlled by electronically-controlled brake booster 1, and the openings of inlet solenoid valves 4FR and 4RR and outlet solenoid valves 5FR and 5RR are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR).

Until time t105 after time t104, the first desired vehicle deceleration Gx1 decreases to zero. In response, the mode 1 continues to be selected in which the drive of electronically-controlled brake booster 1 is enabled and the drive of hydraulic pumps PP and PS is disabled. The control method from time t105 to time t106 is the same as that from time t101 to time t102.

At time t106, the first desired vehicle deceleration Gx1 becomes zero. In response, the mode 0 is selected again.

In this way, the vehicle behavior control apparatus according to the first embodiment pressurizes the second and fourth wheel cylinders by adjusting openings of the second and fourth pressure-increasing valves, in response to determining that a request concerning a longitudinal movement of the vehicle and constituting the first operation request turns present under condition that the first and third wheel cylinders are pressurized by operating the first hydraulic system in response to a request concerning a yaw movement of the vehicle and constituting the first operation request, opening the first and third pressure-increasing valves, and closing the second and fourth pressure-increasing valves. Then, the vehicle behavior control apparatus depressurizes the second and fourth wheel cylinders by adjusting openings of the second and fourth pressure-reducing valves, in response to determining that a request concerning a longitudinal movement of the vehicle and constituting the first operation request turns absent under condition that internal pressures of the first, second, third and fourth wheel cylinders are controlled by operating the first hydraulic system in response to the first operation request, opening the first and third pressure-increasing valves, and adjusting openings of the second and fourth pressure-increasing valves. This allows the total braking force to increase for control of the dynamic behavior of the vehicle under condition that the yawing moment is held constant for control of the dynamic behavior of the vehicle.

The thus-constructed vehicle behavior control apparatus according to the first embodiment produces the following advantageous effects (1) to (4).

(1) The vehicle behavior control apparatus according to the first embodiment includes a hydraulic circuit (1, 31, M/C) hydraulically connected to a wheel cylinder (W/C(FL), W/C(FR), W/C(RL), W/C(RR)) of a vehicle, the hydraulic circuit (1, 31, M/C) including a first hydraulic system (1) for pressurizing the wheel cylinder (W/C(FL), W/C(FR), W/C(RL), W/C(RR)) by operating a master cylinder (M/C), and a second hydraulic system (M) for pressurizing the wheel cylinder (W/C(FL), W/C(FR), W/C(RL), W/C(RR)) independently of operation of the master cylinder (M/C); and a control unit (32) for controlling the hydraulic circuit (1, 31, M/C), the control unit (32) being configured to: determine whether a first operation request (Gx1, M1) according to a physical relationship between the vehicle and an environment surrounding the vehicle is present or absent; determine whether a second operation request (Gx2, M2) according to a physical behavior of the vehicle is present or absent; activate the first hydraulic system (1) in response to determining that the first operation request (Gx1, M1) is present and the second operation request (Gx2, M2) is absent (transition A from mode 0 to mode 1); activate the second hydraulic system (M) in response to determining that the first operation request (Gx1, M1) is absent and the second operation request (Gx2, M2) is present (transition C from mode 0 to mode 2); and keep the first hydraulic system (1) activated and activate the second hydraulic system (M), in response to determining that the second operation request (Gx2, M2) turns present under condition that the first hydraulic system (1) is activated in response to the first operation request (Gx1, M1) (transition E from mode 1 to mode 3).

Since the two operation requests are satisfied by two independent functions of the vehicle behavior control apparatus, the vehicle behavior control apparatus according to the first embodiment can control the vehicle behavior in consideration of the dynamic behavior of the vehicle and the physical relationship between the host vehicle and the environmental conditions, providing a desirable brake pedal feel when the driver is operating the brake pedal.

When a change of the vehicle behavior is requested on the basis of the environmental conditions, the wheel cylinder pressures are controlled similarly as in the normal braking in which fluid communication between the master cylinder M/C and the wheel cylinders W/C(FL), W/C(FR), W/C(RL) and W/C(RR) are allowed. When the diver increases the depression of the brake pedal, the vehicle behavior control apparatus according to the first embodiment can enter the normal braking mode without rapid change or fluctuations in the wheel cylinder pressures P(FL), P(FR), P(RL) and P(RR). On the other hand, when a change of the vehicle behavior is requested on the basis of the identified dynamic behavior of the vehicle, the wheel cylinder pressures are controlled under condition that fluid communication between master cylinder M/C and wheel cylinders W/C(FL), W/C(FR), W/C(RL) and W/C(RR) is inhibited. When the driver depresses down the brake pedal, the wheel cylinder pressures P(FL), P(FR), P(RL) and P(RR) are not transmitted to the driver through the brake pedal. Moreover, the vehicle behavior can be quickly changed in a short period which is achieved by using both of the two different functions of pressurizing the wheel cylinder pressures P(FL), P(FR), P(RL) and P(RR).

(2) In the vehicle behavior control apparatus according to the first embodiment, the control unit (32) keeps the first hydraulic system (1) activated and deactivates the second hydraulic system (M), in response to determining that the second operation request (Gx2, M2) turns absent under condition that both of the first and second hydraulic systems (1, M) are activated (transition F from mode 3 to mode 1); and keeps the second hydraulic system (M) activated and deactivates the first hydraulic system (1), in response to determining that the first operation request (Gx1, M1) turns absent under condition that both of the first and second hydraulic systems (1, M) are activated (transition G from mode 3 to mode 2).

Since the wheel cylinder pressures P(FL), P(FR), P(RL) and P(RR) are controlled by the two functions, the mode shift, from the mode in which both of the two functions are enabled, to the mode in which only one of the two functions is enabled, can be smoothly implemented without making the driver uncomfortable.

(3) In the vehicle behavior control apparatus according to the first embodiment, the control unit (32) enables the first hydraulic system (1) and disables the second hydraulic system (M) in response to determining that the first operation request (Gx1, M1) is present and the second operation request (Gx2, M2) is absent.

In case the second operation request occurs when only the first operation request is present, the vehicle behavior control apparatus according to the first embodiment can smoothly implement the second operation request by activating one of the functions which is not employed for the first operation request.

(4) In the vehicle behavior control apparatus according to the first embodiment, the control unit (32) keeps the first hydraulic system (1) disabled, even when determining that the first operation request (Gx1, M1) turns present under condition that the second operation request (Gx2, M2) is present.

When in the mode 2, outlet gate valves 3P and 3S are closed, a first set of two of inlet solenoid valves 4FL, 4FR, 4RL and 4RR are opened, and a second set of the other two of inlet solenoid valves 4FL, 4FP, 4RL and 4RR are closed. If the drive of electronically-controlled brake booster 1 is set enabled under such a condition, then outlet gate valves 3P and 3S are opened, so that the master cylinder pressure P_mc produced by electronically-controlled brake booster 1 is supplied to the first set of two of inlet solenoid valves 4FL, 4FR, 4RL and 4RR which are opened, but not supplied to the second set of the other two of inlet solenoid valves 4FL, 4FR, 4RL and 4RR which are closed. This may make the vehicle behavior unstable. The vehicle behavior control apparatus according to the first embodiment inhibits the mode shift from the mode 2 to the mode 3, and thereby prevents the vehicle behavior from getting unstable.

### Second Embodiment

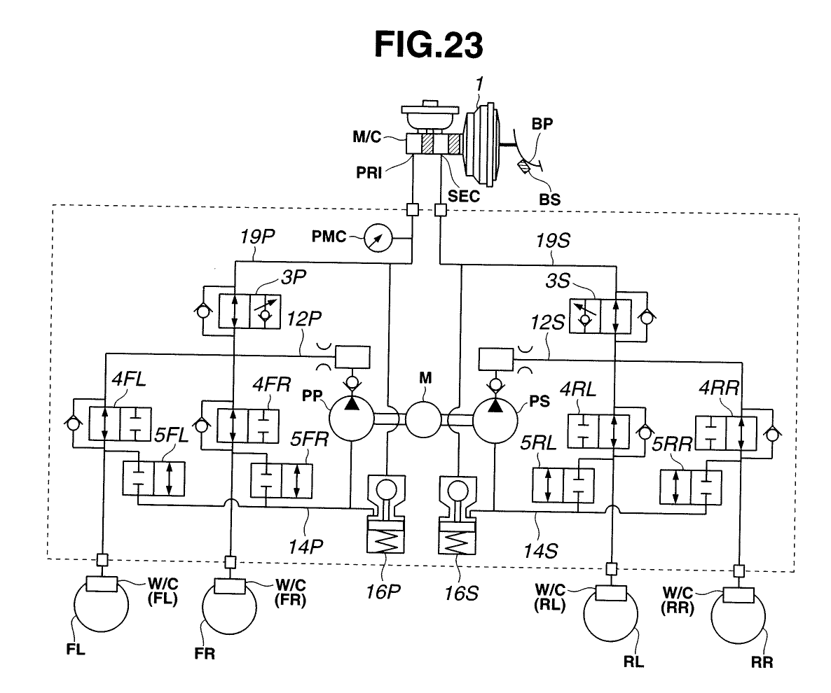

A vehicle behavior control apparatus or system according to a second embodiment of the present invention has a construction similar to that of the first embodiment. The following specifically describes modified aspects of the second embodiment as compared to the first embodiment. The system configuration of an automotive vehicle provided with the vehicle behavior control apparatus according to the second embodiment is the same as shown in FIG. 1 in the first embodiment.

<Construction of Brake System> FIG. 23 schematically shows a brake system of the vehicle behavior control apparatus according to the second embodiment. The brake system includes a hydraulic circuit of so called an H-pipe arrangement, which includes a subsystem or section “P” and a subsystem or section “S”.

The section P is hydraulically connected to front left and right wheel cylinders W/C(FL) and W/C(FR). The section S is hydraulically connected to rear left and right wheel cylinders W/C(RL) and W/C(RR). The sections P and S include hydraulic pumps PP and PS, respectively, which are driven by the single electric motor M.

Brake switch BS is provided at brake pedal BP for measuring or identifying a state of operation of brake pedal BP. Brake pedal BP is connected to master cylinder M/C through the electronically-controlled brake booster 1.

Master cylinder M/C includes a first output port “PRI” and a second output port “SEC”. When outlet gate valve 3P is opened by de-energizing, and inlet solenoid valve 4FL is opened by de-energizing, as shown in FIG. 23, then the first output port PRI hydraulically communicates with front left wheel cylinder W/C(FL) through fluid passage 19P, outlet gate valve 3P and inlet solenoid valve 4FL. Similarly, when outlet gate valve 3P is opened by de-energizing, and inlet solenoid valve 4FR is opened by de-energizing, as shown in FIG. 23, then the first output port PRI hydraulically communicates with front right wheel cylinder W/C(FR) through fluid passage 19P, outlet gate valve 3P and inlet solenoid valve 4FR.

Pressure sensor PMC is arranged to measure the hydraulic pressure in fluid passage 19P. Outlet gate valve 3P is opened by de-energizing or closed by energizing, allowing or inhibiting fluid communication in fluid passage 19P between master cylinder M/C and front left and right wheel cylinders W/C(FL) and W/C(FR). Outlet gate valve 3P thus serves as a means for shutting off master cylinder M/C from front left and right wheel cylinders W/C(FL) and W/C(FR).

Inlet solenoid valves 4FL and 4FR are opened by de-energizing or closed by energizing, allowing or inhibiting fluid communication between respective ones of front left and right wheel cylinders W/C(FL) and W/C(FR) and fluid passage 19P or fluid passage 12P.

Hydraulic pump PP is driven by electric motor M. Hydraulic pump PP has a suction port hydraulically connected to internal reservoir 16P, pressurizes the brake fluid supplied from internal reservoir 16P, and discharges it through a discharge port. When outlet gate valve 3P is opened by de-energizing, the discharge port of hydraulic pump PP hydraulically communicates with master cylinder M/C through fluid passage 12P, outlet gate valve 3P, and fluid passage 19P. When inlet solenoid valves 4FL and 4FR are opened by de-energizing, then the discharge port of hydraulic pump PP hydraulically communicates with front left and right wheel cylinders W/C(FL) and W/C(FR) through fluid passage 12P and inlet solenoid valves 4FL and 4FR.

Outlet solenoid valve 5FL, which is a normally closed electromagnetic valve, is disposed in a fluid passage branched from the fluid passage connected between inlet solenoid valve 4FL and front left wheel cylinder W/C(FL), and connected to fluid passage 14P leading to internal reservoir 16P. Outlet solenoid valve 5FL is opened by energizing or closed by de-energizing, allowing or inhibiting fluid communication between front left wheel cylinder W/C(FL) and fluid passage 14P. Similarly, outlet solenoid valve 5FR, which is a normally closed electromagnetic valve, is disposed in a fluid passage branched from the fluid passage connected between inlet solenoid valve 4FL and front right wheel cylinder W/C(FR), and connected to fluid passage 14P leading to internal reservoir 16P. Outlet solenoid valve 5FR is opened by energizing or closed by de-energizing, allowing or inhibiting fluid communication between front right wheel cylinder W/C(FR) and fluid passage 14P.

When outlet gate valve 3S is opened by de-energizing, and inlet solenoid valve 4RL is opened by de-energizing, as shown in FIG. 23, then the second output port SEC hydraulically communicates with rear left wheel cylinder W/C(RL) through fluid passage 19S, outlet gate valve 3S and inlet solenoid valve 4RL. When outlet gate valve 3S is opened by de-energizing, and inlet solenoid valve 4RR is opened by de-energizing, as shown in FIG. 23, then the second output port SEC hydraulically communicates with rear right wheel cylinder W/C(RR) through fluid passage 19S, outlet gate valve 3S and inlet solenoid valve 4RR.

Outlet gate valve 3S is opened by de-energizing or closed by energizing, allowing or inhibiting fluid communication in fluid passage 19S between master cylinder M/C and rear left and right wheel cylinders W/C(RL) and W/C(RR). Outlet gate valve 35 thus serves as a means for shutting off master cylinder M/C from rear left and right wheel cylinders W/C(RL) and W/C(RR).

Inlet solenoid valves 4RL and 4RR are opened by de-energizing or closed by energizing, allowing or inhibiting fluid communication between respective ones of rear left and right wheel cylinders W/C(RL) and W/C(RR) and fluid passage 19S or fluid passage 12S.

Hydraulic pump PS is driven by electric motor M. Hydraulic pump PS has a suction port hydraulically connected to internal reservoir 16S, pressurizes the brake fluid supplied from internal reservoir 16S, and discharges it through a discharge port. When outlet gate valve 3S is opened by de-energizing, the discharge port of hydraulic pump PS hydraulically communicates with master cylinder M/C through fluid passage 12S, outlet gate valve 3S, and fluid passage 19S. When inlet solenoid valves 4RL and 4RR are opened by de-energizing, then the discharge port of hydraulic pump PS hydraulically communicates with rear left and right wheel cylinders W/C(RL) and W/C(RR) through fluid passage 12S and inlet solenoid valves 4RL and 4RR.

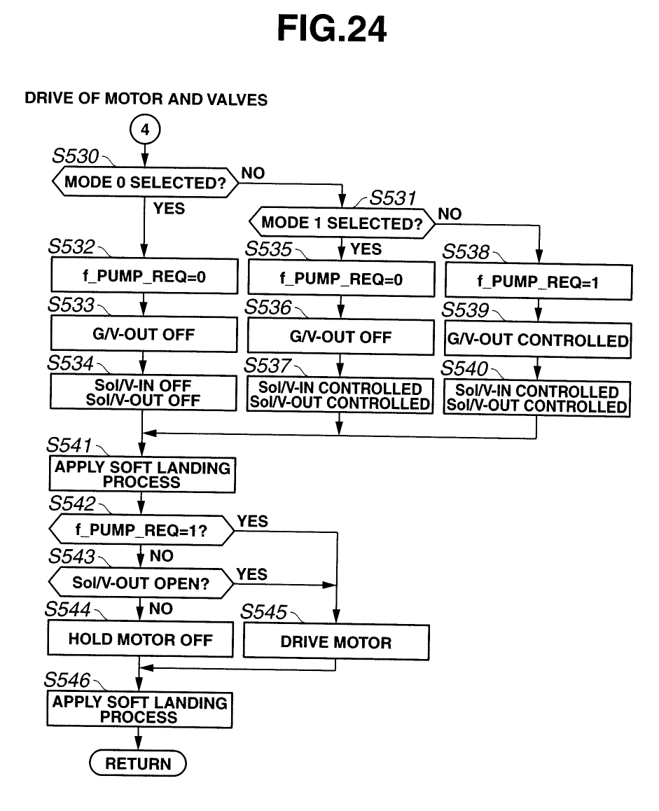

Outlet solenoid valve 5RL, which is a normally closed electromagnetic valve, is disposed in a fluid passage branched from the fluid passage connected between inlet solenoid valve 4RL and rear left wheel cylinder W/C(RL), and connected to fluid passage 14S leading to internal reservoir 16S. Outlet solenoid valve 5RL is opened by energizing or closed by de-energizing, allowing or inhibiting fluid communication between rear left wheel cylinder W/C(RL) and fluid passage 14S. Similarly, outlet solenoid valve 5RR, which is a normally closed electromagnetic valve, is disposed in a fluid passage branched from the fluid passage connected between inlet solenoid valve 4RL and rear right wheel cylinder W/C(RR), and connected to fluid passage 14S leading to internal reservoir 16S. Outlet solenoid valve 5RR is opened by energizing or closed by de-energizing, allowing or inhibiting fluid communication between rear right wheel cylinder W/C(RR) and fluid passage 14S.

<Drive of Motor and Valves> FIG. 24 shows a sub process according to the second embodiment for drive of the motor and valves which is entered from the flow chart of FIG. 4. Control unit 32 is configured to operate as follows.

At Step S530, control unit 32 determines whether or not the mode 0 is currently selected. When the answer to Step S530 is YES, then control unit 32 proceeds to Step S532, at which control unit 32 resets the pump request flag f_PUMP_REQ to zero, then proceeds to Step S533, at which control unit 32 sets the outlet gate valves 3P and 3S de-energized, then proceeds to Step S534, at which control unit 32 sets the inlet solenoid valves 4FL, 4FR, 4RL and 4RR and outlet solenoid valves 5FL, 5FR, 5RL and 5RR de-energized, then proceeds to Step S541, at which control unit 32 applies a soft landing process for preventing the wheel cylinder pressures from rapidly changing or vibrating, and then proceeds to Step S542. On the other hand, when the answer to Step S530 is NO, then control unit 32 proceeds to Step S531.

At Step S531, control unit 32 determines whether or not the mode 1 is currently selected. When the answer to Step S531 is YES, then control unit 32 proceeds to Step S535, at which control unit 32 resets the pump request flag f_PUMP_REQ to zero, then proceeds to Step S536, at which control unit 32 sets the outlet gate valves 3P and 3S de-energized, then proceeds to Step S537, at which control unit 32 controls the openings of the inlet solenoid valves 4FL, 4FR, 4RL and 4RR and outlet solenoid valves 5FL, 5FR, 5RL and 5RR on the basis of the desired master cylinder pressure P*_mc, the desired wheel cylinder pressures P*(FL), P*(FR), P*(RL) and P*(RR) and the measured wheel cylinder pressures P(FL), P(FR), P(RL) and P(RR), and then proceeds to Step S541. On the other hand, when the answer to Step S531 is NO, that is, when the mode 2 or 3 is currently selected, then control unit 32 proceeds to Step S538.

At Step S538, control unit 32 sets the pump request flag f_PUMP_REQ to 1, then proceeds to Step S539, at which control unit 32 controls the outlet gate valves 3P and 3S on the basis of the desired wheel cylinder pressures P*(FL), P*(FR), P*(RL) and P*(RR), and the measured wheel cylinder pressures P(FL), P(FR), P(RL) and P(RR), then proceeds to Step S540, at which control unit 32 controls the openings of the inlet solenoid valves 4FL, 4FR, 4RL and 4RR and outlet solenoid valves 5FL, 5FR, 5RL and 5RR on the basis of the desired wheel cylinder pressures P*(FL), P*(FR), P*(RL) and P*(RR) and the measured wheel cylinder pressures P(FL), P(FR), P(RL) and P(RR), and then is proceeds to Step S541.

At Step S542, control unit 32 determines whether or not the pump request flag f_PUMP_REQ is equal to 1. When the answer to Step S542 is YES, then control unit 32 proceeds to Step S545, at which control unit 32 controls the operation of electric motor M on the basis of the desired wheel cylinder pressures P*(FL), P*(FR), P*(RL) and P*(RR) and the measured wheel cylinder pressures P(FL), P(FR), P(RL) and P(RR), then proceeds to Step S546, at which control unit 32 applies a soft landing process in order to prevent the wheel cylinder pressures from rapidly changing or vibrating, and then returns from this control process to Step S2 in the flow chart of FIG. 4. On the other hand, when the answer to Step S542 is NO, then control unit 32 proceeds to Step S543.

At Step S543, control unit 32 determines whether or not the outlet solenoid valves 5FL, 5FR, 5RL and 5RR are currently opened even if temporarily. When the answer to Step S543 is YES, then control unit 32 proceeds to Step S545, at which control unit 32 controls the operation of electric motor M on the basis of the amount of the brake fluid stored in internal reservoirs 16P and 16S. On the other hand, when the answer to Step S543 is NO, then control unit 32 proceeds to Step S544, at which control unit 32 sets the electric motor M de-energized, and then proceeds to Step S546.

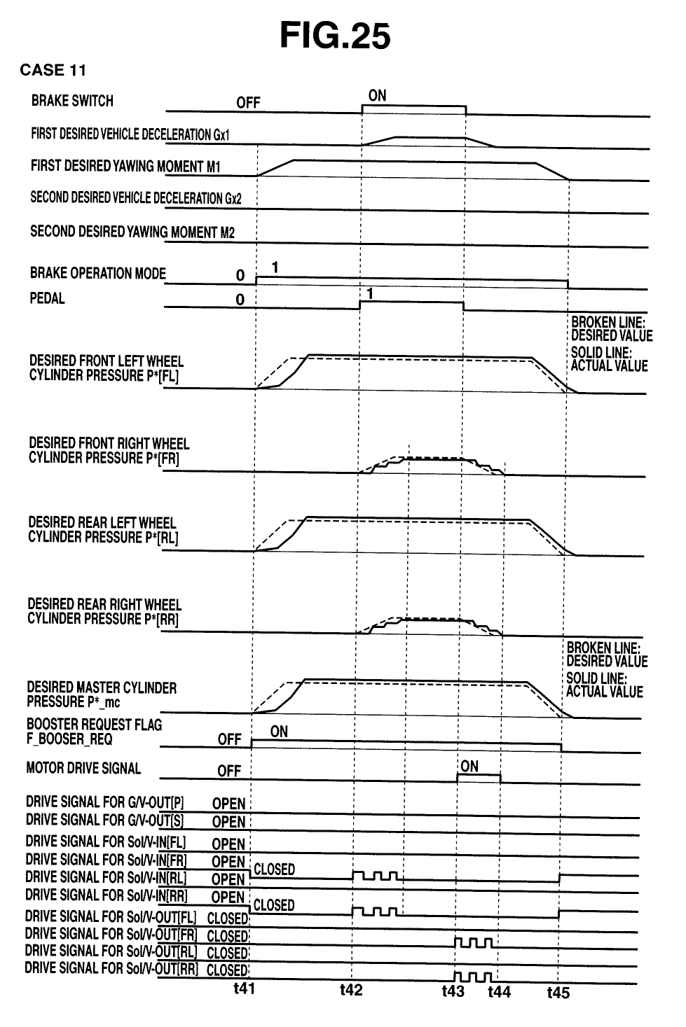

FIG. 25 shows a case of operation of the vehicle behavior control apparatus according to the second embodiment. In this case, the vehicle behavior control apparatus shifts from the mode 0 through the transition A to the mode 1 in the diagram of FIG. 3, and then brake pedal BP is depressed by the driver.

At time t41, the first desired yawing moment M1 occurs when in the mode 0. In response, the mode 1 is newly selected in which the drive of electronically-controlled brake booster 1 is enabled and the drive of hydraulic pumps PP and PS is disabled.

On the basis of the first desired yawing moment M1, the desired wheel cylinder pressures P*(FL), P*(FR), P*(RL) and P*(RR) are computed. In order to attain the first desired yawing moment M1 that is positive and in the counterclockwise direction, the desired front and rear left wheel cylinder pressures P*(FL) and P*(RL) are set suitably, and the desired front and rear right wheel cylinder pressures P*(FR) and P*(RR) are set to zero. Moreover, the desired master cylinder pressure P*_mc is set to the maximum value of the desired wheel cylinder pressures P*(FL), P*(FR), P*(RL) and P*(RR), and the booster request flag f_BOOSER_REQ is set to 1.

There is no brake pedal operation by the driver, so that brake switch BS is off. Accordingly, the brake pedal operation mode number PEDAL is set to zero.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, and outlet gate valves 3P and 3S are de-energized. Moreover, inlet solenoid valves 4FL and 4RL and outlet solenoid valves 5FL, 5FR, 5RL and 5RR are de-energized, and inlet solenoid valves 4FR and 4RR are closed by energizing, for the front and rear left wheel cylinder pressures P(FL) and P(RL) to be automatically controlled by electronically-controlled brake booster 1.

At time t42, the driver operates the brake pedal BP. In response, brake switch BS is turned on. Simultaneously, the first desired vehicle deceleration Gx1 occurs. In response, the mode 1 continues to be selected in which the drive of electronically-controlled brake booster 1 is enabled and the drive of hydraulic pumps PP and PS is disabled.

On the basis of the first desired vehicle deceleration Gx1 and the first desired yawing moment M1, the desired wheel cylinder pressures P*(FL), P*(FR), P*(RL) and P*(RR) are computed. The desired front and rear right wheel cylinder pressures P*(FR) and P*(RR) are suitably increased from zero, in order to attain the first desired vehicle deceleration Gx1. The desired master cylinder pressure P*_mc is set to the maximum value of the desired wheel cylinder pressures P*(FL), P*(FR), P*(RL) and P*(RR), and the booster request flag f_BOOSER_REQ is set to 1.

At the time, brake switch BS is on, but, when the amount of brake pedal operation is below the controlled hydraulic pressure of electronically-controlled brake booster 1, then the brake pedal operation mode number PEDAL is set to 1.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, electric motor M, and outlet gate valves 3P and 3S are de-energized. Moreover, inlet solenoid valves 4FL and 4RL and outlet solenoid valves 5FL and 5RL are de-energized, and the openings of inlet solenoid valves 4FR and 4RR and outlet solenoid valves 5FR and 5RR are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR).

At time t43, the driver releases the brake pedal BP. In response, brake switch BS is turned off. Simultaneously, the first desired vehicle deceleration Gx1 decreases. In response, the mode 1 continues to be selected in which the drive of electronically-controlled brake booster 1 is enabled and the drive of hydraulic pumps PP and PS is disabled.

On the basis of the first desired yawing moment M1, the desired wheel cylinder pressures P*(FL), P*(FR), P*(RL) and P*(RR) are computed. The desired master cylinder pressure P*_mc is set to the maximum value of the desired wheel cylinder pressures P*(FL), P*(FR), P*(RL) and P*(RR), and the booster request flag f_BOOSER_REQ is set to 1.

At the time, brake switch BS is off, and then the brake pedal operation mode number PEDAL is set to 0.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pumps PP and PS is disabled, outlet gate valves 3P and 3S are de-energized. Moreover, inlet solenoid valves 4FL and 4RL and outlet solenoid valves 5FL and 5RL are de-energized, and the openings of inlet solenoid valves 4FR and 4RR and outlet solenoid valves 5FR and 5RR are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR).

Since outlet solenoid valves 5FR and 5RR are opened temporarily, electric motor M is driven in order to return the brake fluid in internal reservoirs 16P and 16S to master cylinder M/C.

Thereafter, the control method is the same as that from time t11 to time t21 in the case of FIG. 13.

In this way, when the driver operates the brake pedal under condition that the yawing moment is generated by the vehicle behavior control in the mode 1 (in which the drive of electronically-controlled brake booster 1 is enabled and the drive of hydraulic pumps PP and PS is disabled), the vehicle behavior control apparatus according to the second embodiment can control the dynamic behavior of the vehicle by producing suitable braking forces at the road wheels that have been subject to no braking forces before the brake pedal operation. Thus, even when the vehicle behavior control is active, the driver's brake pedal operation can be satisfied.

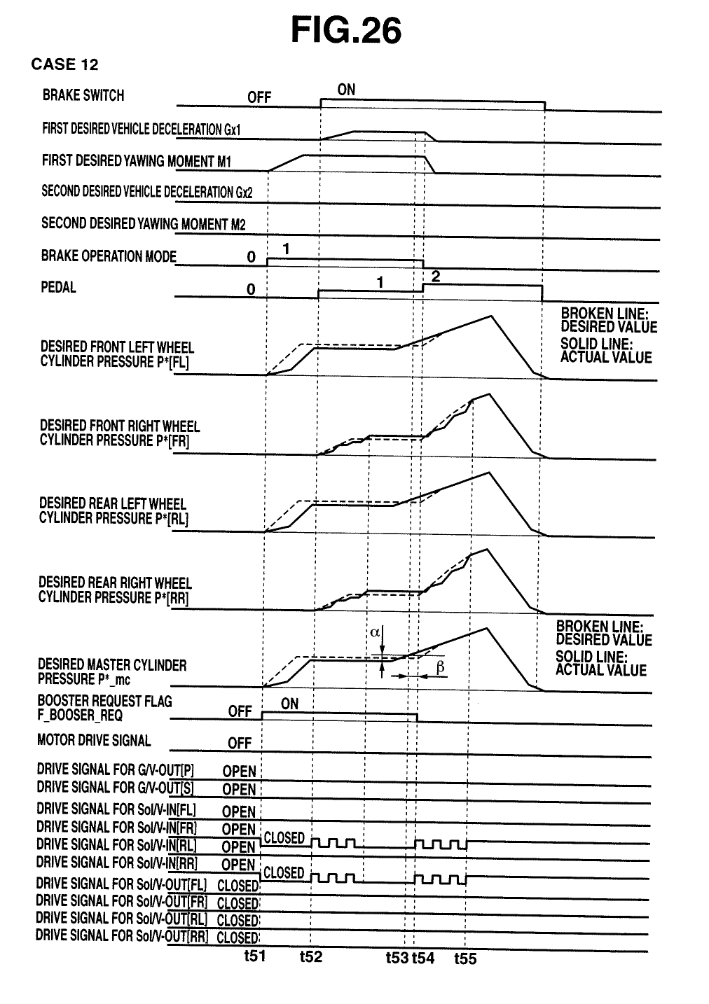

FIG. 26 shows a case of operation of the vehicle behavior control apparatus according to the second embodiment. In this case, the vehicle behavior control apparatus shifts from the mode 0 through the transition A to the mode 1 in the diagram of FIG. 3, and then brake pedal BP is deeply depressed by the driver. Until time t53, the control method is the same as that from time t41 to time t43 in the case of FIG. 25.

At time t53, the driver increases the depression of brake pedal BP. In response, the difference between the desired master cylinder pressure P*_mc and the master cylinder pressure P_mc exceeds the predetermined reference value α. During the brake pedal identification at Step S11 of the flow chart of FIG. 4, the counter value COUNT starts to be incremented.

When the predetermined reference period of time P has elapsed after time t53 under condition that the difference between the desired master cylinder pressure P*_mc and the master cylinder pressure P_mc is larger than the predetermined reference value α, then it is identified that the driver has increased the depression of brake pedal BP, and then the brake pedal operation mode number PEDAL is set to 2.

At time t54, the first desired vehicle deceleration Gx1 and the first desired yawing moment M1 decrease to zero. In response, the mode 0 is selected again. The soft landing process is applied to operations of the electronically-controlled brake booster 1 and the valves at Steps 403 and S541, respectively. After a delay, the shift to the mode 0 (for normal braking) is completed at time t55.

In this way, when the driver increases the depression of the brake pedal under condition that the yawing moment is generated by the vehicle behavior control in the mode 1 (in which the drive of electronically-controlled brake booster 1 is enabled and the drive of hydraulic pumps PP and PS is disabled), the vehicle behavior control apparatus according to the second embodiment can control the dynamic behavior of the vehicle by setting the wheel cylinder pressures equal to the master cylinder pressure, and then shifts to the mode 0. Thus, when the driver's brake pedal operation is above the controlled hydraulic pressure, the vehicle behavior control apparatus prioritizes the driver's brake pedal operation, so as for the driver not to feel uncomfortable.

### Third Embodiment

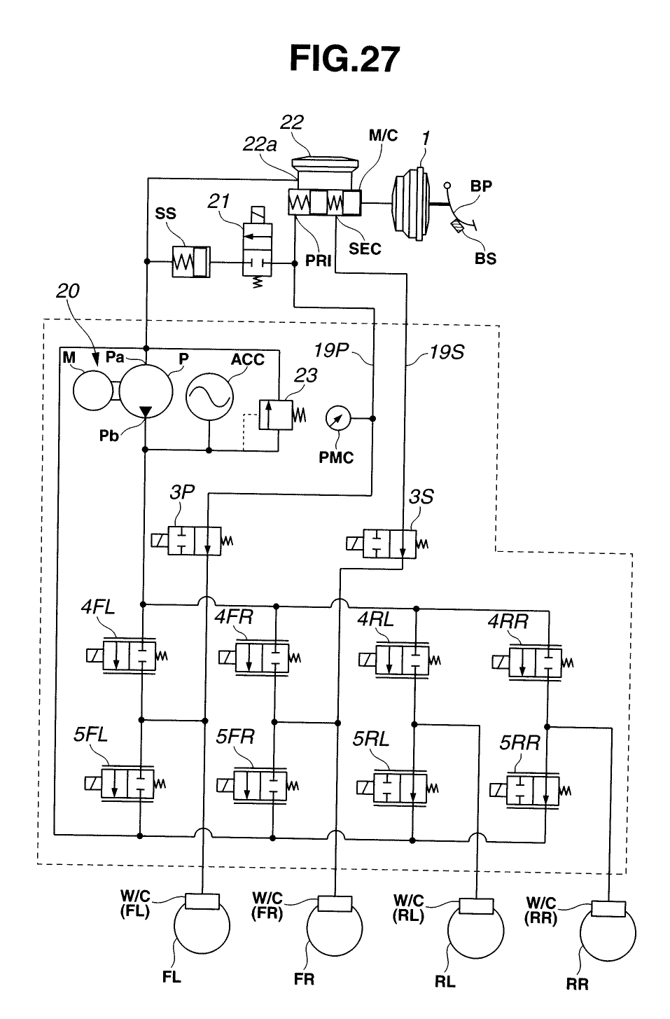

A vehicle behavior control apparatus or system according to a third embodiment of the present invention has a construction similar to that of the first embodiment. The following specifically describes modified aspects of the third embodiment as compared to the first embodiment. The system configuration of an automotive vehicle provided with the vehicle behavior control apparatus according to the third embodiment is the same as shown in FIG. 1 in the first embodiment.

<Construction of Brake System> FIG. 27 schematically shows a brake system of the vehicle behavior control apparatus according to the third embodiment. The brake system is so called a brake-by-wire system including the master cylinder M/C that generates a hydraulic pressure according to a state of depression of brake pedal BP, and a pressure supply section 20 that supplies hydraulic pressures to wheel cylinders W/C(FL), W/C(FR), W/C(RL) and W/C(RR) independently of master cylinder M/C.

When pressure supply section 20 is normal, then pressure supply section 20 supplies to wheel cylinders W/C(FL), W/C(FR), W/C(RL) and W/C(RR) hydraulic pressures which are regulated according to the state of depression of brake pedal BP. On the other hand, when pressure supply section 20 is abnormal, then the hydraulic pressures are supplied to wheel cylinders W/C(FL), W/C(FR), W/C(RL) and W/C(RR) by master cylinder M/C which is mechanically connected to brake pedal BP.

The hydraulic circuit includes a stroke simulator “SS” for allowing a stroke of brake pedal BP, when pressure supply section 20 is abnormal. Brake switch BS is provided at brake pedal BP for measuring or identifying a state of operation of brake pedal BP.

Master cylinder M/C includes first output port PRI and second output port SEC through which substantially identical hydraulic pressures are supplied. The first output port PRI is hydraulically connected to front left wheel cylinder W/C(FL) through fluid passage 19P. Outlet gate valve 3P, which is a normally open electromagnetic valve, is disposed in fluid passage 19P. When outlet gate valve 3P is opened by de-energizing, then the first output port PRI hydraulically communicates with front left wheel cylinder W/C(FL) through outlet gate valve 3P. Pressure sensor PMC is provided in fluid passage 19P between master cylinder M/C and outlet gate valve 3P for measuring the internal pressure of fluid passage 19P or master cylinder M/C.

The second output port SEC is hydraulically connected to front right wheel cylinder W/C(FR) through fluid passage 19S. Outlet gate valve 3S, which is a normally open electromagnetic valve, is disposed in fluid passage 19S. When outlet gate valve 3S is opened by de-energizing, then the second output port SEC hydraulically communicates with front right wheel cylinder W/C(FR) through outlet gate valve 3S.

Outlet gate valves 3P and 3S are opened by de-energizing or closed by energizing, allowing or inhibiting fluid communication between master cylinder M/C and respective ones of front left and right wheel cylinders W/C(FL) and W/C(FR). When pressure supply section 20 is normal, then outlet gate valves 3P and 3S are closed by energizing, so as to inhibit fluid communication between master cylinder M/C and respective ones of front left and right wheel cylinders W/C(FL) and W/C(FR). On the other hand, when pressure supply section 20 is abnormal, then outlet gate valves 3P and 3S are opened by de-energizing, so as to allow fluid communication between master cylinder M/C and respective ones of front left and right wheel cylinders W/C(FL) and W/C(FR).

Stroke simulator SS is hydraulically connected to a point in fluid passage 19P between master cylinder M/C and outlet gate valve 3P through a fluid passage. A cancel valve 21, which is a normally closed electromagnetic valve, is provided in the fluid passage between master cylinder M/C and stroke simulator SS. Stroke simulator SS serves to absorb the brake fluid supplied through the first output port PRI from master cylinder M/C. In the flow charts and time charts, cancel valve 21 is denoted by “Can/V”.

When cancel valve 21 is de-energized, then cancel valve 21 shuts off stroke simulator SS and the first output port PRI of master cylinder M/C from each other. On the other hand, when cancel valve 21 is energized, then cancel valve 21 allows fluid communication between the stroke simulator SS and the first output port PRI of master cylinder M/C.

When pressure supply section 20 is normal, then cancel valve 21 is energized, allowing fluid communication between the stroke simulator SS and the first output port PRI of master cylinder M/C. On the other hand, when pressure supply section 20 is abnormal, then cancel valve 21 is de-energized, shutting off stroke simulator SS and the first output port PRI of master cylinder M/C from each other.

Pressure supply section 20 includes electric motor M, a hydraulic pump “P”, and an accumulator “ACC”. Hydraulic pump P is driven by electric motor M, and draws in by suction a brake fluid in a reservoir tank “22” through a suction port “Pa”, and discharges the brake fluid under pressure through a discharge port “Pb”.

Accumulator ACC hydraulically communicates with the discharge port Pb of hydraulic pump P, stores the pressurized brake fluid supplied from hydraulic pump P under condition of a constant pressure level, and supplies the brake fluid to wheel cylinders W/C(FL), W/C(FR), W/C(RL) and W/C(RR) as occasion arises. A relief valve 23 is hydraulically connected between a point upstream from the suction port Pa and a point downstream from the discharge port Pb. Relief valve 23 is closed when the discharge pressure of the brake fluid by hydraulic pump P is below a certain threshold value, and is opened when the discharge pressure is above the certain threshold value. Pressure supply section 20 thus supplies the brake fluid under a predetermined high pressure to wheel cylinders W/C(FL), W/C(FR), W/C(RL) and W/C(RR).

When inlet solenoid valve 4FL, which is a normally closed electromagnetic valve, is energized, then pressure supply section 20 hydraulically communicates with front left wheel cylinder W/C(FL) through inlet solenoid valve 4FL. Inlet solenoid valve 4FL is opened by energizing or closed by de-energizing, allowing or inhibiting fluid communication between pressure supply section 20 and front left wheel cylinder W/C(FL). When outlet solenoid valve 5FL, which is a normally closed electromagnetic valve, is energized, then front left wheel cylinder W/C(FL) hydraulically communicates with reservoir tank 22 through outlet solenoid valve 5FL. Outlet solenoid valve 5FL is opened by energizing or closed by de-energizing, allowing or inhibiting fluid communication between front left wheel is cylinder W/C(FL) and reservoir tank 22.

When inlet solenoid valve 4FR, which is a normally closed electromagnetic valve, is energized, then pressure supply section 20 hydraulically communicates with front right wheel cylinder W/C(FR) through inlet solenoid valve 4FR. Inlet solenoid valve 4FR is opened by energizing or closed by de-energizing, allowing or inhibiting fluid communication between pressure supply section 20 and front right wheel cylinder W/C(FR). When outlet solenoid valve 5FR, which is a normally closed electromagnetic valve, is energized, then front right wheel cylinder W/C(FR) hydraulically communicates with reservoir tank 22 through outlet solenoid valve 5FR. Outlet solenoid valve 5FR is opened by energizing or closed by de-energizing, allowing or inhibiting fluid communication between front right wheel cylinder W/C(FR) and reservoir tank 22.

When inlet solenoid valve 4RL, which is a normally closed electromagnetic valve, is energized, then pressure supply section 20 hydraulically communicates with rear left wheel cylinder W/C(RL) through inlet solenoid valve 4RL. Inlet solenoid valve 4RL is opened by energizing or closed by de-energizing, allowing or inhibiting fluid communication between pressure supply section 20 and rear left wheel cylinder W/C(RL). When outlet solenoid valve 5RL, which is a normally open electromagnetic valve, is de-energized, then rear left wheel cylinder W/C(RL) hydraulically communicates with reservoir tank 22 through outlet solenoid valve 5RL. Outlet solenoid valve 5RL is opened by de-energizing or closed by energizing, allowing or inhibiting fluid communication between rear left wheel cylinder W/C(RL) and reservoir tank 22.

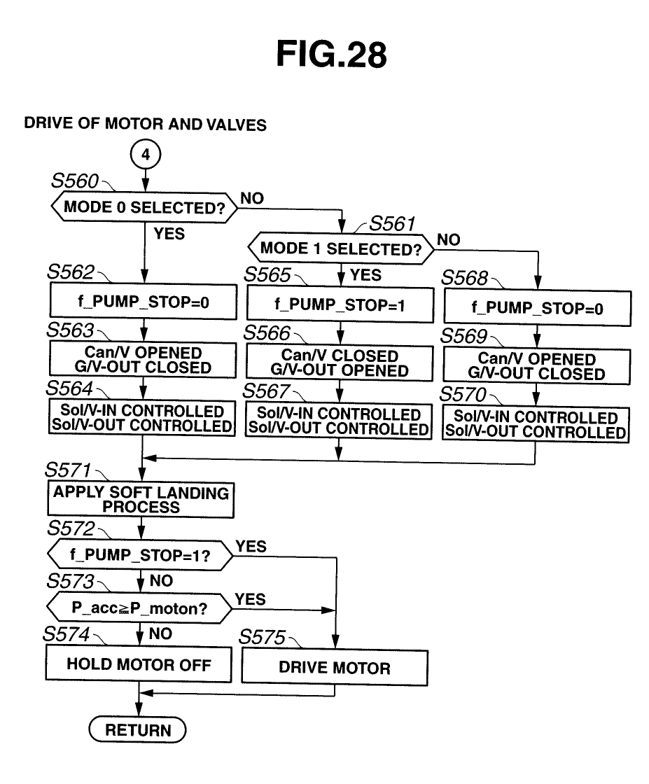

When inlet solenoid valve 4RR, which is a normally closed electromagnetic valve, is energized, then pressure supply section 20 hydraulically communicates with rear right wheel cylinder W/C(RR) through inlet solenoid valve 4RR. Inlet solenoid valve 4RR is opened by energizing or closed by de-energizing, allowing or inhibiting fluid communication between pressure supply section 20 and rear right wheel cylinder W/C(RR). When outlet solenoid valve 5RR, which is a normally open electromagnetic valve, is de-energized, then rear right wheel cylinder W/C(RR) hydraulically communicates with reservoir tank 22 through outlet solenoid valve 5RR. Outlet solenoid valve 5RR is opened by de-energizing or closed by energizing, allowing or inhibiting fluid communication between rear right wheel cylinder W/C(RR) and reservoir tank 22.

<Drive of Motor and Valves> FIG. 28 shows a sub process according to the third embodiment for drive of the motor and valves which is entered from the flow chart of FIG. 4. Control unit 32 is configured to operate as follows.

At Step S560, control unit 32 determines whether or not the mode 0 is currently selected. When the answer to Step S560 is YES, then control unit 32 proceeds to Step S562, at which control unit 32 resets the pump stop flag f_PUMP_STOP to 0, then proceeds to Step S563, at which control unit 32 sets the cancel valve 21 opened and sets the outlet gate valves 3P and 3S closed, then proceeds to Step S564, at which control unit 32 controls the openings of the inlet solenoid valves 4FL, 4FR, 4RL and 4RR and outlet solenoid valves 5FL, 5FR, 5RL and 5RR on the basis of comparison between the desired wheel cylinder pressures P*(FL), P*(FR), P*(RL) and P*(RR) and the measured wheel cylinder pressures P(FL), P(FR), P(RL) and P(RR), then proceeds to Step S571, at which control unit 32 applies a soft landing process for preventing the wheel cylinder pressures from rapidly changing or vibrating, and then proceeds to Step S572. On the other hand, when the answer to Step S560 is NO, then control unit 32 proceeds to Step S561.

At Step S561, control unit 32 determines whether or not the mode 1 is currently selected. When the answer to Step S561 is YES, then control unit 32 proceeds to Step S565, at which control unit 32 sets the pump stop flag f_PUMP_STOP to 1, then proceeds to Step S566, at which control unit 32 sets the cancel valve 21 closed and sets the outlet gate valves 3P and 3S opened, then proceeds to Step S567, at which control unit 32 controls the openings of the inlet solenoid valves 4FL, 4FR, 4RL and 4RR and outlet solenoid valves 5FL, 5FR, 5RL and 5RR on the basis of the desired master cylinder pressure P*_mc, the desired wheel cylinder pressures P*(FL), P*(FR), P*(RL) and P*(RR) and the measured wheel cylinder pressures P(FL), P(FR), P(RL) and P(RR), and then proceeds to Step S571. On the other hand, when the answer to Step S561 is NO, that is, when the mode 2 or 3 is currently selected, then control unit 32 proceeds to Step S568.

At Step S568, control unit 32 resets the pump stop flag f_PUMP_STOP to 0, then proceeds to Step S569, at which control unit 32 sets the cancel valve 21 opened and sets the outlet gate valves 3P and 3S closed, then proceeds to Step S570, at which control unit 32 controls the openings of the inlet solenoid valves 4FL, 4FR, 4RL and 4RR and outlet solenoid valves 5FL, 5FR, 5RL and 5RR on the basis of the desired wheel cylinder pressures P*(FL), P*(FR), P*(RL) and P*(RR) and the measured wheel cylinder pressures P(FL), P(FR), P(RL) and P(RR), and then proceeds to Step S571.

At Step S572, control unit 32 determines whether or not the pump stop flag f_PUMP_STOP is equal to 1. When the answer to Step S572 is YES, then control unit 32 proceeds to Step S575, at which control unit 32 sets the electric motor M de-energized, and then returns from this control process to Step S2 in the flow chart of FIG. 4. On the other hand, when the answer to Step S572 is NO, then control unit 32 proceeds to Step S573.

At Step S573, control unit 32 determines whether or not an accumulator pressure “P_acc” is above a predetermined reference pressure value “P_moton”. When the answer to Step S573 is YES, that is, when the accumulator pressure P_acc is sufficiently high, then control unit 32 proceeds to Step S575, at which control unit 32 sets the electric motor M de-energized. On the other hand, when the answer to Step S573 is NO, then control unit 32 proceeds to Step S574, at which control unit 32 controls or drives the electric motor M.

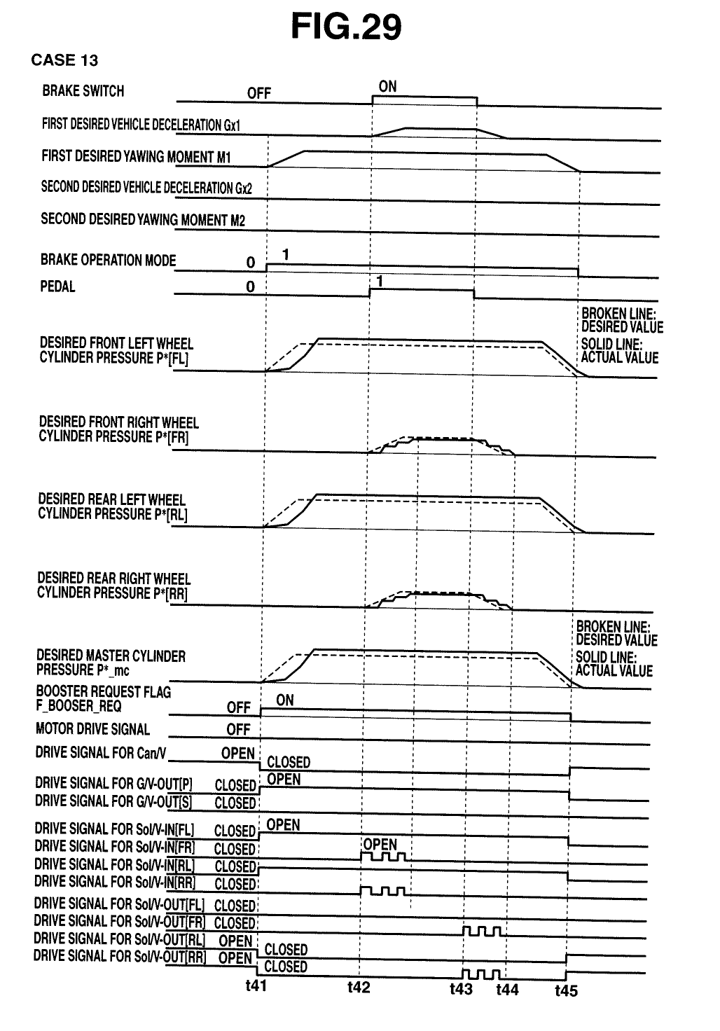

FIG. 29 shows a case of operation of the vehicle behavior control apparatus according to the third embodiment. In this case, the vehicle behavior control apparatus shifts from the mode 0 through the transition A to the mode 1 in the diagram of FIG. 3, and then brake pedal BP is depressed by the driver.

At time t41, the first desired yawing moment M1 occurs when in the mode 0. In response, the mode 1 is newly selected in which the drive of electronically-controlled brake booster 1 is enabled and the drive of hydraulic pump P is disabled.

On the basis of the first desired yawing moment M1, the desired wheel cylinder pressures P*(FL), P*(FR), P*(RL) and P*(RR) are computed. In order to attain the first desired yawing moment M1 that is positive and in the counterclockwise direction, the desired front and rear left wheel cylinder pressures P*(FL) and P*(RL) are set suitably, and the desired front and rear right wheel cylinder pressures P*(FR) and P*(RR) are set to zero. Moreover, the desired master cylinder pressure P*_mc is set to the maximum value of the desired wheel cylinder pressures P*(FL), P*(FR), P*(RL) and P*(RR), and the booster request flag f_BOOSER_REQ is set to 1.

There is no brake pedal operation by the driver, so that brake switch BS is off. Accordingly, the brake pedal operation mode number PEDAL is set to zero.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is is energized and driven.

Since the drive of hydraulic pump P is disabled, electric motor M is de-energized, cancel valve 21 is closed by de-energizing, outlet gate valve 3P is opened by de-energizing, and outlet gate valve 3S is closed by energizing. Moreover, inlet solenoid valves 4FL and 4RL are opened, outlet solenoid valves 5FL and 5RL are closed, inlet solenoid valves 4FR and 4RR are closed, and outlet solenoid valves 5FR and 5RR are closed, for the front and rear left wheel cylinder pressures P(FL) and P(RL) to be automatically controlled by electronically-controlled brake booster 1.

At time t42, the driver operates the brake pedal BP. In response, brake switch BS is turned on. Simultaneously, the first desired vehicle deceleration Gx1 occurs. In response, the mode 1 continues to be selected in which the drive of electronically-controlled brake booster 1 is enabled and the drive of hydraulic pump P is disabled.

On the basis of the first desired vehicle deceleration Gx1 and the first desired yawing moment M1, the desired wheel cylinder pressures P*(FL), P*(FR), P*(RL) and P*(RR) are computed. The desired front and rear right wheel cylinder pressures P*(FR) and P*(RR) are suitably increased from zero, in order to attain the first desired vehicle deceleration Gx1. The desired master cylinder pressure P*_mc is set to the maximum value of the desired wheel cylinder pressures P*(FL), P*(FR), P*(RL) and P*(RR), and the booster request flag f_BOOSER_REQ is set to 1.

At the time, brake switch BS is on, but, when the is amount of brake pedal operation is below the controlled hydraulic pressure of electronically-controlled brake booster 1, then the brake pedal operation mode number PEDAL is set to 1.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pump P is disabled, electric motor M is de-energized, cancel valve 21 is closed by de-energizing, outlet gate valve 3P is opened by de-energizing, and outlet gate valve 3S is closed by energizing. Moreover, inlet solenoid valves 4FL and 4RL are opened, outlet solenoid valves 5FL and 5RL are closed, and the openings of inlet solenoid valves 4FR and 4RR and outlet solenoid valves 5FR and 5RR are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR).

At time t43, the driver releases the brake pedal BP. In response, brake switch BS is turned off. Simultaneously, the first desired vehicle deceleration Gx1 decreases. In response, the mode 1 continues to be selected in which the drive of electronically-controlled brake booster 1 is enabled and the drive of hydraulic pump P is disabled.

On the basis of the first desired yawing moment M1, the desired wheel cylinder pressures P*(FL), P*(FR), P*(RL) and P*(RR) are computed. The desired master cylinder pressure P*_mc is set to the maximum value of the desired wheel cylinder pressures P*(FL), P*(FR), P*(RL) and P*(RR), and the booster request flag f_BOOSER_REQ is set to 1.

At the time, brake switch BS is off, and then the brake pedal operation mode number PEDAL is set to 0.

Since the booster request flag f_BOOSER_REQ is equal to 1, the drive current value is set on the basis of comparison between the desired master cylinder pressure P*_mc and the master cylinder pressure P_mc, and accordingly, the electronically-controlled brake booster 1 is energized and driven.

Since the drive of hydraulic pump P is disabled, electric motor M is de-energized, cancel valve 21 is closed by de-energizing, outlet gate valve 3P is opened by de-energizing, and outlet gate valve 3S is closed by energizing. Moreover, inlet solenoid valves 4FL and 4RL are opened, outlet solenoid valves 5FL and 5RL are closed, and the openings of inlet solenoid valves 4FR and 4RR and outlet solenoid valves 5FR and 5RR are controlled by opening and closing on the basis of comparison between the desired wheel cylinder pressures P*(FL), P*(FR), P*(RL) and P*(RR) and the measured wheel cylinder pressures P(FL), P(FR), P(RL) and P(RR). At the time, the control process proceeds through Steps S560, S561, S565, S566, S567, S571, S572 and S575.

Thereafter, the control method is the same as that from time t11 to time t21 in the case of FIG. 13.

In this way, when the driver operates the brake pedal under condition that the yawing moment is generated by the vehicle behavior control in the mode 1 (in which the drive of electronically-controlled brake booster 1 is enabled and the drive of hydraulic pump P is disabled), the vehicle behavior control apparatus according to the third embodiment can control the dynamic behavior of the vehicle by producing suitable braking forces at the road wheels that have been subject to no braking forces before the brake pedal operation. Thus, even when the vehicle behavior control is active, the driver's brake pedal operation can be satisfied.

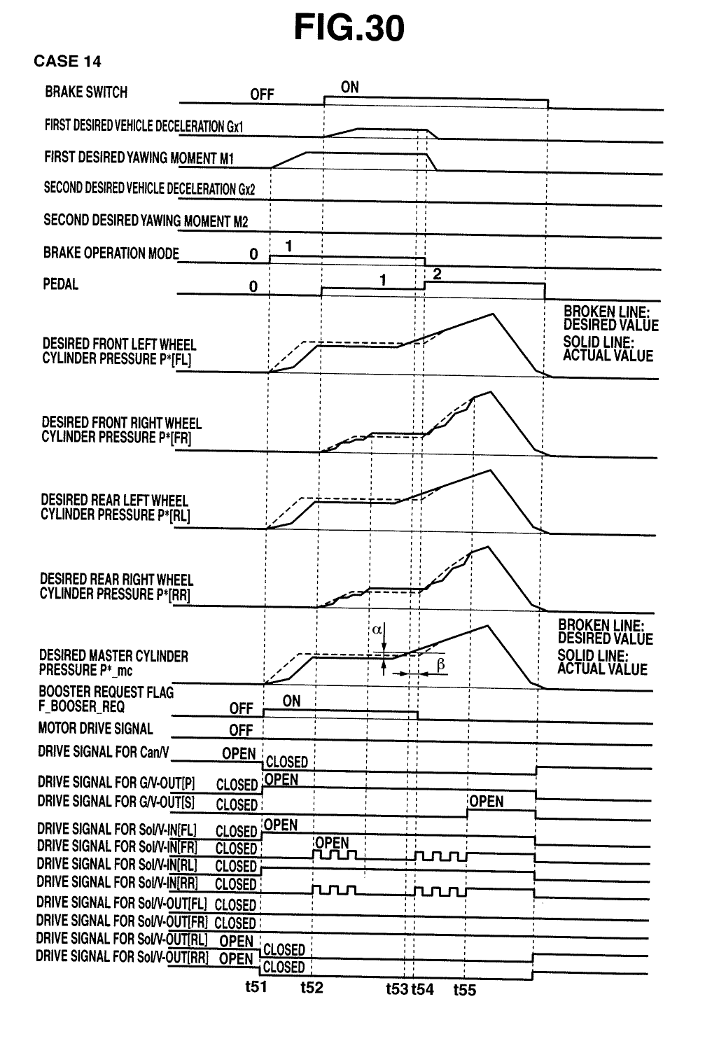

FIG. 30 shows a case of operation of the vehicle behavior control apparatus according to the third embodiment. In this case, the vehicle behavior control apparatus shifts from the mode 0 through the transition A to the mode 1 in the diagram of FIG. 3, and then brake pedal BP is deeply depressed by the driver. Until time t53, the control method is the same as that from time t41 to time t43 in the case of FIG. 29.

At time t53, the driver increases the depression of brake pedal BP. In response, the difference between the desired master cylinder pressure P*_mc and the master cylinder pressure P_mc exceeds the predetermined reference value α. During the brake pedal identification at Step S11 of the flow chart of FIG. 4, the counter value COUNT starts to be incremented.

When the predetermined reference period of time P has elapsed after time t53 under condition that the difference between the desired master cylinder pressure P*_mc and the master cylinder pressure P_mc is larger than the predetermined reference value α, then it is identified that the driver has increased the depression of brake pedal BP, and then the brake pedal operation mode number PEDAL is set to 2.

At time t54, the first desired vehicle deceleration Gx1 and the first desired yawing moment M1 decrease to zero. In response, the mode 0 is selected. The soft landing process is applied to operations of the electronically-controlled brake booster 1 and the valves at Steps 403 and S571, respectively. After a delay, the shift to the mode 0 (for normal braking) is completed at time t55.

In this way, when the driver increases the depression of the brake pedal under condition that the yawing moment is generated by the vehicle behavior control in the mode 1 (in which the drive of electronically-controlled brake booster 1 is enabled and the drive of hydraulic pump P is disabled), the vehicle behavior control apparatus according to the third embodiment can control the dynamic behavior of the vehicle by setting the wheel cylinder pressures equal to the master cylinder pressure, and then shifts to the mode 0. Thus, when the driver's brake pedal operation is above the controlled hydraulic pressure, the vehicle behavior control apparatus prioritizes the driver's brake pedal operation, so as for the driver not to feel uncomfortable.

The present embodiments described above may be modified as follows. For example, the amount of the brake pedal may be measured by a stroke sensor. Alternatively, the amount of the brake pedal may be measured by a sensor for sensing a force depressing the brake pedal. Such a sensor can monitor the brake pedal more accurately. Accordingly, when a yawing moment is to be generated, it is possible to control wheel cylinder pressures of outer two of the road wheels on the basis of the amount of operation of the brake pedal, therefore control the dynamic behavior of the vehicle as intended by the driver, although the wheel cylinder pressures of the outer two road wheels are set to zero in the foregoing embodiments.

At Step S10, the desired yawing moment may be implemented by setting only one of the desired wheel cylinder pressures P*(FL), P*(FR), P*(RL) and P*(RR) which is related to a front inner wheel during cornering. This results in a small slip rate of the rear wheels, and thereby enhances the stability of the vehicle behavior when the steering wheel is operated by the driver.

At Step S10, the desired yawing moment may be implemented by setting only one of the desired wheel cylinder pressures P*(FL), P*(FR), P*(RL) and P*(RR) which is related to a rear inner wheel during cornering. This causes no change in the front left and right wheel cylinder pressures P(FL) and P(FR), and causes no vibration to the steering wheel, and thereby prevents the driver from feeling uncomfortable.

Drive signals for the valves may be signals of on-duty ratio. This allows precise control of the openings of the valves, and prevents the driver from feeling uncomfortable.

Drive signals for the motor may be a signal of on-duty ratio. This allows precise control of the speed of the motor, and prevents the driver from feeling uncomfortable.

This application is based on a prior Japanese Patent Application No. 2007-145206 filed on May 31, 2007. The entire contents of this Japanese Patent Application No. 2007-145206 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A vehicle behavior control apparatus comprising:
a master cylinder arranged to pressurize a wheel cylinder of a vehicle in accordance with operation of a brake pedal of the vehicle;
a first pressurizing section arranged to pressurize the wheel cylinder by operating the master cylinder independently of operation of the brake pedal;
a second pressurizing section arranged to pressurize the wheel cylinder independently of operation of the master cylinder; and
a control unit for controlling the first and second pressurizing sections, the control unit being configured to:
determine whether a first operation request according to a physical relationship between the vehicle and an environment surrounding the vehicle is present or absent;
determine whether a second operation request according to a physical behavior of the vehicle is present or absent;
activate the first pressurizing section in response to determining that the first operation request is present and the second operation request is absent;
activate the second pressurizing section in response to determining that the first operation request is absent and the second operation request is present; and
keep the first pressurizing section activated and activate the second pressurizing section, in response to determining that the second operation request turns present under condition that the first pressurizing section is activated in response to the first operation request.

2. The vehicle behavior control apparatus as claimed in claim 1, wherein the control unit is further configured to:
keep the first pressurizing section activated and deactivate the second pressurizing section, in response to determining that the second operation request turns absent under condition that both of the first and second pressurizing sections are activated; and
keep the second pressurizing section activated and deactivate the first pressurizing section, in response to determining that the first operation request turns absent under condition that both of the first and second pressurizing sections are activated.

3. The vehicle behavior control apparatus as claimed in claim 1, wherein the control unit is further configured to disable the second pressurizing section in response to determining that the first operation request is present and the second operation request is absent.

4. The vehicle behavior control apparatus as claimed in claim 3, wherein the control unit is further configured to keep the first pressurizing section disabled in response to determining that the first operation request turns present when the first operation request is absent and the second operation request is present.

5. The vehicle behavior control apparatus as claimed in claim 4, wherein:
the first pressurizing section includes a controllable brake booster for assisting a driver to operate the brake pedal by operating the master cylinder; and
the second pressurizing section includes a pressure supply section for controlling an internal pressure of the wheel cylinder independently of operation of the brake pedal.

6. The vehicle behavior control apparatus as claimed in claim 5, wherein the pressure supply section includes a hydraulic pump.

7. The vehicle behavior control apparatus as claimed in claim 1, further comprising:
at least one of a camera and a radar mounted on the vehicle for collecting information used to determine the physical relationship between the vehicle and the environment; and
a sensor mounted on the vehicle for collecting information used to determine the physical behavior of the vehicle.

8. A vehicle behavior control apparatus comprising:
a master cylinder arranged to pressurize a wheel cylinder of a vehicle in accordance with operation of a brake pedal of the vehicle;
a first pressurizing section arranged to pressurize the wheel cylinder by operating the master cylinder independently of operation of the brake pedal;
a second pressurizing section arranged to pressurize the wheel cylinder independently of operation of the master cylinder; and
a control unit for controlling the first and second pressurizing sections, the control unit being configured to:
perform a first control operation of pressurizing the wheel cylinder by operating the first pressurizing section;
perform a second control operation of pressurizing the wheel cylinder by operating the second pressurizing section; and
continue the first control operation and start the second control operation, after starting the first control operation.

9. The vehicle behavior control apparatus as claimed in claim 8, wherein the control unit is further configured to:
determine whether a first operation request according to a physical relationship between the vehicle and an environment surrounding the vehicle is present or absent;
determine whether a second operation request according to a physical behavior of the vehicle is present or absent;
continue the first control operation and terminate the second control operation, in response to determining that the second operation request turns absent under condition that both of the first and second control operations are performed; and
continue the second control operation and terminate the first control operation, in response to determining that the first operation request turns absent under condition that both of the first and second control operations are performed.

10. The vehicle behavior control apparatus as claimed in claim 9, wherein the control unit is further configured to disable the second pressurizing section in response to determining that the first operation request is present and the second operation request is absent.

11. The vehicle behavior control apparatus as claimed in claim 10, wherein the control unit is further configured to keep the first pressurizing section disabled in response to determining that the first operation request turns present when the first operation request is absent and the second operation request is present.

12. The vehicle behavior control apparatus as claimed in claim 11, further comprising:
at least one of a camera and a radar mounted on the vehicle for collecting information used to determine the physical relationship between the vehicle and the environment; and
a sensor mounted on the vehicle for collecting information used to determine the physical behavior of the vehicle.

13. The vehicle behavior control apparatus as claimed in claim 11, wherein:
the first pressurizing section includes a controllable brake booster for assisting a driver to operate the brake pedal by operating the master cylinder; and
the second pressurizing section includes a pressure supply section for controlling an internal pressure of the wheel cylinder independently of operation of the brake pedal.

14. The vehicle behavior control apparatus as claimed in claim 13, wherein the pressure supply section includes a hydraulic pump.

15. A vehicle behavior control apparatus comprising:
a hydraulic circuit hydraulically connected to a wheel cylinder of a vehicle, the hydraulic circuit including:
a master cylinder arranged to pressurize the wheel cylinder in accordance with operation of a brake pedal of the vehicle;
a first pressurizing section for pressurizing the wheel cylinder by operating the master cylinder independently of operation of the brake pedal;
a second pressurizing section for pressurizing the wheel cylinder independently of operation of the master cylinder, the second pressurizing section including a pressure supply section for supplying a hydraulic pressure independently of operation of the master cylinder;
a first fluid passage hydraulically connected between the master cylinder and the wheel cylinder;
a second fluid passage hydraulically connected between a first portion of the first fluid passage and a discharge port of the pressure supply section;
a check valve disposed in the second fluid passage for allowing an operating fluid to flow from the discharge port of the pressure supply section to the first fluid passage, and preventing the operating fluid from flowing inversely;
an outlet gate valve disposed in the first fluid passage between the master cylinder and the first portion of the first fluid passage;
a third fluid passage hydraulically connected between a suction port of the pressure supply section and a second portion of the first fluid passage, the second portion being disposed between the master cylinder and the outlet gate valve;
an inlet gate valve disposed in the third fluid passage for selectively allowing and inhibiting fluid communication between the master cylinder and the suction port of the pressure supply section;
an inlet valve disposed in the first fluid passage between the wheel cylinder and the first portion of the first fluid passage;
a fourth fluid passage hydraulically connected between the suction port of the pressure supply section and a third portion of the first fluid passage, the third portion being disposed between the inlet valve and the wheel cylinder;
an outlet valve disposed in the fourth fluid passage, the outlet valve being a normally closed valve; and
a reservoir disposed in the fourth fluid passage between the outlet valve and the suction port of the pressure supply section; and
a control unit for controlling the hydraulic circuit, the control unit being configured to:
close the outlet gate valve and open the inlet gate valve, in response to determining that the second pressurizing section is activated;
open the outlet gate valve and close the inlet gate valve, in response to determining that the first pressurizing section is activated; and
open the inlet gate valve, in response to determining that the second pressurizing section is activated under condition that the first pressurizing section is activated.

16. The vehicle behavior control apparatus as claimed in claim 15, wherein the control unit is further configured to:
keep the first pressurizing section activated and deactivate the second pressurizing section, in response to determining that the second operation request turns absent under condition that both of the first and second pressurizing sections are activated; and
keep the second pressurizing section activated and deactivate the first pressurizing section, in response to determining that the first operation request turns absent under condition that both of the first and second pressurizing sections are activated.

17. The vehicle behavior control apparatus as claimed in claim 15, wherein the control unit is further configured to disable the second pressurizing section in response to determining that the first operation request is present and the second operation request is absent.

18. The vehicle behavior control apparatus as claimed in claim 17, wherein the control unit is further configured to keep the first pressurizing section disabled in response to determining that the first operation request turns present when the first operation request is absent and the second operation request is present.

19. The vehicle behavior control apparatus as claimed in claim 18, further comprising:
at least one of a camera and a radar mounted on the vehicle for collecting information used to determine the physical relationship between the vehicle and the environment; and
a sensor mounted on the vehicle for collecting information used to determine the physical behavior of the vehicle.

20. The vehicle behavior control apparatus as claimed in claim 18, wherein:
the first pressurizing section includes a controllable brake booster for assisting a driver to operate the brake pedal by operating the master cylinder; and
the second pressurizing section includes a pressure supply section for controlling an internal pressure of the wheel cylinder independently of operation of the brake pedal.

21. The vehicle behavior control apparatus as claimed in claim 20, wherein the pressure supply section includes a hydraulic pump.
